(19) United States
(12) Patent Application Publication
(10) Pub. No.: US 2025/0334213 A1
(43) Pub. Date: Oct. 30, 2025

(54) HYBRID HOSE ASSEMBLIES AND ASSEMBLY METHODS

(71) Applicant: Swagelok Company, Solon, OH (US)

(72) Inventors: Stephen J. Zaborszki, Northfield Center, OH (US); Corey Pasheilich, Solon, OH (US); Branden W. Keeper, Mentor, OH (US); Douglas A. Nordstrom, Shaker Heights, OH (US); Jeffrey Trumbull, Painesville, OH (US)

(21) Appl. No.: 19/192,741

(22) Filed: Apr. 29, 2025

Related U.S. Application Data
(60) Provisional application No. 63/640,373, filed on Apr. 30, 2024.

(51) Int. Cl. F16L 11/112; F16L 11/118

(52) U.S. Cl. CPC F16L 11/112; F16L 11/118

(57) ABSTRACT

A hose assembly includes an inner tube, a connector, a collar, and an outer metal conduit. The connector includes a stem portion inserted into a distal end of the inner tube and a body portion extending radially outward and axially rearward of the stem portion. The collar is substantially coaxial with and surrounds the distal end of the inner tube, with the collar being in radial compression against the inner tube. The outer metal conduit is substantially coaxial with and surrounds the inner tube and the collar, with the outer metal conduit terminating at a distal end welded to the body portion of the connector.

### CROSS-REFERENCE TO RELATED APPLICATION

This application claims priority to and all benefit of U.S. Provisional Patent Application Ser. No. 63/640,373, filed Apr. 30, 2024 and entitled HYBRID HOSE ASSEMBLIES AND ASSEMBLY METHODS, the entire disclosure of which is incorporated herein by reference.

### TECHNICAL FIELD OF THE INVENTIONS

The present disclosure relates to flexible hose assemblies for fluid containment and transfer under a variety of pressures and temperatures between two points, and to methods of making such hose assemblies. More particularly, the disclosure relates to multi-layer or “hybrid” flexible hose assemblies having a first layer providing a first property (e.g., cleanability) and a second layer providing a second property (e.g., gas impermeability).

### SUMMARY OF THE DISCLOSURE

In accordance with an embodiment of one or more of the inventions presented in this disclosure, a hose assembly includes an inner tube, a connector, a collar, and an outer metal conduit. The connector includes a stem portion inserted into a distal end of the inner tube and a body portion extending radially outward and axially rearward of the stem portion. The collar is substantially coaxial with and surrounds the distal end of the inner tube, with the collar being in radial compression against the inner tube. The outer metal conduit is substantially coaxial with and surrounds the inner tube and the collar, with the outer metal conduit terminating at a distal end welded to the body portion of the connector.

In accordance with another embodiment of one or more of the inventions presented in this disclosure, a hose assembly includes an inner tube, a connector including a stem portion inserted into a distal end of the inner tube and a body portion extending radially outward and axially rearward of the stem portion, a first outer metal conduit substantially coaxial with and surrounding the inner tube and the collar, the outer metal conduit terminating at a distal end attached to the body portion of the connector, and a second outer metal conduit substantially coaxial with and surrounding the first outer metal conduit, with the second outer metal conduit terminating at a distal end portion attached to one of the first outer metal conduit and the connector.

In accordance with another embodiment of one or more of the inventions presented in this disclosure, a method of making a hose assembly includes the steps of installing a distal end of an inner tube over a stem portion of a connector, installing a collar over the distal end of the inner tube, deforming the collar into radial compression against the distal end of the inner tube, extending an outer metal conduit over the inner tube and the collar, and welding a distal end of the outer metal conduit to a body portion of the connector extending radially outward and axially rearward of the stem portion.

In accordance with another embodiment of one or more of the inventions presented in this disclosure, a method of making a hose assembly is contemplated. In an exemplary method, a distal end of an inner tube is installed over a stem portion of a connector, and a collar is installed over the distal end of the inner tube. The collar is deformed into radial compression against the distal end of the inner tube. An outer metal conduit is extended over the inner tube and the collar, and a distal end of the outer metal conduit is welded to a body portion of the connector extending radially outward and axially rearward of the stem portion.

In accordance with another embodiment of one or more of the inventions presented in this disclosure, a hose assembly includes an inner tube, a connector including a stem portion inserted into a distal end of the inner tube, a corrugated outer metal tube substantially coaxial with and surrounding the inner tube, with a distal endmost corrugation truncated to define a counterbore portion, and a collar substantially coaxial with and surrounding the distal end of the inner tube, the collar including a distal portion in radial compression against the inner tube and a proximal portion received in and welded to the counterbore portion of the outer metal tube.

In accordance with another embodiment of one or more of the inventions presented in this disclosure, a method of making a hose assembly is contemplated. In an exemplary method, a corrugated outer metal tube is provided, having a distal endmost corrugation truncated to define a counterbore portion. A proximal portion of a collar is received in the counterbore portion of the outer metal tube, and the proximal portion of the collar is welded to the counterbore portion of the outer metal tube. A distal end of an inner tube is inserted through the outer metal tube and the collar. A stem portion of a connector is inserted into the distal end of the inner tube. A distal portion of the collar is crimped into radial compression against the inner tube for radial compression of the inner tube against the stem portion of the connector.

In accordance with another embodiment of one or more of the inventions presented in this disclosure, a hose assembly includes an inner tube, an outer metal conduit substantially coaxial with and surrounding the inner tube, and a connector including a proximal end portion closely receiving a distal end portion of the outer metal conduit, an intermediate portion in radial compression against a distal end portion of the inner tube, and a distal end portion defining an end connection, wherein the proximal end portion of the connector is welded to the distal end portion of the outer metal conduit.

In accordance with another embodiment of one or more of the inventions presented in this disclosure, a method of making a hose assembly includes the steps of receiving a distal portion of an outer metal conduit into a proximal end portion of a connector, welding the proximal end portion of the connector to the distal end portion of the outer metal conduit; receiving a distal portion of an inner tube within the outer metal conduit and into an intermediate portion of the connector, with a distal end portion of the connector extending beyond the inner tube to define an end connection, and crimping the intermediate portion of the connector into radial compression against the distal end portion of the inner tube.

### BRIEF DESCRIPTION OF THE DRAWINGS

Further advantages and benefits will become apparent to those skilled in the art after considering the following description and appended claims in conjunction with the accompanying drawings, in which:

FIG. 1 is a schematic cross-sectional view of an end portion of a hose assembly, in accordance with an exemplary embodiment of the present disclosure;

FIG. 2 is a cross-sectional view of an end portion of a hose assembly in accordance with another exemplary embodiment of the present disclosure, shown in a preassembled condition;

FIG. 3 is a cross-sectional view of the hose assembly of FIG. 2, shown with the collar compressed against the inner tube and connector;

FIG. 3A is a cross-sectional view of an end portion of a hose assembly in accordance with another exemplary embodiment of the present disclosure, shown with an end portion of the collar staked into an annular recess in the connector;

FIG. 3B is a cross-sectional view of an end portion of a hose assembly in accordance with another exemplary embodiment of the present disclosure, shown with an end portion of the inner tube reinforcement layer captured between the collar and the connector flange;

FIG. 4 is a cross-sectional view of the hose assembly of FIG. 2, shown with the outer tube welded to the connector;

FIG. 5 is a cross-sectional view of an end portion of a hose assembly in accordance with another exemplary embodiment of the present disclosure;

FIG. 6 is a cross-sectional view of the hose assembly of FIG. 5, shown in a preassembled condition;

FIG. 7 is a cross-sectional view of the hose assembly of FIG. 5, shown with the inner collar compressed against the inner tube and connector;

FIG. 8 is a cross-sectional view of the hose assembly of FIG. 5, shown with the outer collar loosely installed on the outer tube;

FIG. 9 is a cross-sectional view of an end portion of a hose assembly in accordance with another exemplary embodiment of the present disclosure;

FIG. 10 is a cross-sectional view of the hose assembly of FIG. 9, shown in a preassembled condition;

FIG. 11 is a cross-sectional view of the hose assembly of FIG. 9, shown with the inner collar compressed against the inner tube and connector, and with the outer collar welded to the outer tube;

FIG. 12 is a cross-sectional view of the hose assembly of FIG. 9, shown with the outer conduit subassembly loosely assembled with the inner conduit subassembly;

FIG. 13 is a cross-sectional view of an end portion of a hose assembly in accordance with another exemplary embodiment of the present disclosure;

FIG. 13A is a cross-sectional view of an end portion of another hose assembly, shown with a fluid system connection coupled to the connector;

FIG. 14 is a cross-sectional view of the hose assembly of FIG. 13, shown in a preassembled condition;

FIG. 15 is a cross-sectional view of the hose assembly of FIG. 13, shown with the collar welded to the outer tube;

FIG. 16 is a cross-sectional view of the hose assembly of FIG. 13, shown with the outer conduit subassembly loosely assembled with the inner conduit subassembly;

FIG. 17A is a cross-sectional view of an end portion of a hose assembly in accordance with another exemplary embodiment of the present disclosure, shown in a pre-crimped, partially assembled condition;

FIG. 17B is a cross-sectional view of the hose assembly of FIG. 17A, shown in a crimped, fully assembled condition;

FIG. 18 is a schematic cross-sectional view of an end portion of a hose assembly, in accordance with another exemplary embodiment of the present disclosure;

FIG. 19 a cross-sectional view of an end portion of a hose assembly in accordance with another exemplary embodiment of the present disclosure;

FIG. 20 is a cross-sectional view of the hose assembly of FIG. 19, shown in a preassembled condition;

FIG. 21 is a cross-sectional view of the hose assembly of FIG. 19, shown with the inner collar compressed against the inner tube and connector, the first outer collar welded to the first outer tube, and the second outer collar welded to the second outer tube;

FIG. 22 is a cross-sectional view of the hose assembly of FIG. 19, shown with the first outer conduit subassembly loosely assembled with the inner conduit subassembly;

FIG. 23 is a cross-sectional view of the hose assembly of FIG. 19, shown with the connector welded to the first outer collar; and

FIG. 24 is a cross-sectional view of the hose assembly of FIG. 19, shown with the first outer conduit and inner conduit subassembly loosely assembled with the second outer conduit subassembly.

### DESCRIPTION OF THE EXEMPLARY EMBODIMENTS

While various inventive aspects, concepts and features of the inventions may be described and illustrated herein as embodied in combination in the exemplary embodiments, these various aspects, concepts and features may be used in many alternative embodiments, either individually or in various combinations and sub-combinations thereof. Unless expressly excluded herein all such combinations and sub-combinations are intended to be within the scope of the present inventions. Still further, while various alternative embodiments as to the various aspects, concepts and features of the inventions—such as alternative materials, structures, configurations, methods, circuits, devices and components, software, hardware, control logic, alternatives as to form, fit and function, and so on—may be described herein, such descriptions are not intended to be a complete or exhaustive list of available alternative embodiments, whether presently known or later developed. Those skilled in the art may readily adopt one or more of the inventive aspects, concepts or features into additional embodiments and uses within the scope of the present inventions even if such embodiments are not expressly disclosed herein. Additionally, even though some features, concepts or aspects of the inventions may be described herein as being a preferred arrangement or method, such description is not intended to suggest that such feature is required or necessary unless expressly so stated. Still further, exemplary or representative values and ranges may be included to assist in understanding the present disclosure, however, such values and ranges are not to be construed in a limiting sense and are intended to be critical values or ranges only if so expressly stated. Parameters identified as “approximate” or “about” a specified value are intended to include both the specified value and values within 10% of the specified value, unless expressly stated otherwise. Further, it is to be understood that the drawings accompanying the present application may, but need not, be to scale, and therefore may be understood as teaching various ratios and proportions evident in the drawings. Moreover, while various aspects, features and concepts may be expressly identified herein as being inventive or forming part of an invention, such identification is not intended to be exclusive, but rather there may be inventive aspects, concepts and features that are fully described herein without being expressly identified as such or as part of a specific invention, the inventions instead being set forth in the appended claims. Descriptions of exemplary methods or processes are not limited to inclusion of all steps as being required in all cases, nor is the order that the steps are presented to be construed as required or necessary unless expressly so stated.

Many applications have requirements for flexible hose to provide a fluid connection between two points in a fluid system, with the flexibility of the hose allowing for various fluid line routing requirements, thermal expansion, misalignment, and intermittent or continuous flexing (e.g., due to system vibrations). In addition to flexibility, different hose properties may be a consideration for use in a particular fluid system, including, for example, system temperature, system pressure, chemical compatibility, resistance to contamination, and gas permeability. In some applications, a first hose material that provides a first property (e.g., resistance to contamination) suitable for the application may have a second property (e.g., gas permeability) that is inadequate for the application. According to an exemplary aspect of the present application, a multi-layer or “hybrid” flexible hose may be provided with an inner tube providing a desired first property, and an outer tube providing a desired second property. While the inner and outer tubes may be laminated or otherwise attached to each other, in some embodiments, the inner and outer tubes may be separate from each other, and even radially spaced apart from each other, for example, to facilitate assembly or function of the hose. To facilitate installation into a fluid system, hose assemblies are commonly provided with any of a variety of connectors, including, for example, tube fittings, tube ends (e.g., for welding or installation in a tube fitting), or quick disconnect couplings, and therefore require a leak-tight connection between the inner and outer flexible hose tube components and the end connection. Accordingly, in one aspect of the present application, an arrangement is provided to join separate inner and outer tube components to a connector.

In an exemplary hybrid hose arrangement, a collar portion has a first end welded to a distal end of an outer metal tube, a second end welded to a connector, and an intermediate portion compressed or crimped against an inner tube to secure the inner tube to a stem portion of the connector inserted into the distal end of the inner tube. One such hybrid hose arrangement is described in co-owned U.S. Pat. No. 11,248,724 (the “'724 Patent”), the entire disclosure of which is incorporated herein by reference.

According to an exemplary aspect of the present disclosure, a hybrid hose assembly having an inner tube and an outer metal conduit may include a connector including a stem portion inserted into a distal end portion of the inner tube, and a body portion welded to a distal end of the metal outer tube. In some such embodiments, a collar may be installed around the distal end portion of the inner tube, and deformed (e.g., crimped) into radial compression against the distal end portion of the inner tube, for example, to secure the inner tube in sealing retention with the connector. Further, by welding the distal end of the metal outer tube directly to the connector body, a second weld on each hose end may be eliminated (e.g., as compared to the hybrid hose arrangement shown in the '724 Patent).

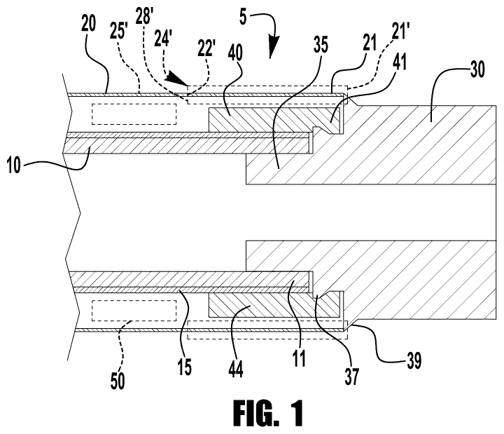

With reference to FIG. 1, a schematic cross-sectional view of an exemplary multi-tube hose 5 is presented. Note that in many of the drawings herein, the components are illustrated in longitudinal or half longitudinal cross-section, it being understood by those skilled in the art that the components are in practice annular parts about a longitudinal centerline axis X. All references herein to “radial” and “axial” are referenced to the X axis except as otherwise noted. Also, all references herein to angles are referenced to the X axis except as may be otherwise noted. Also, while the drawings disclose partial views of a hose assembly provided with a connector at one end, it is understood by those skilled in the art that a second connector (either identical to or different from the illustrated connector) may be provided (e.g., by welding or by some other connection) at an opposite end of the hose assembly.

In the illustrated embodiment, the hose 5 includes an inner tube 10, an outer conduit 20, a connector 30 secured to distal ends 11, 21 of the inner tube and outer conduit, and a collar 40 surrounded by the outer conduit and in radial compression against the inner tube distal end 11 and the connector to secure the inner tube in sealing retention with the connector. The connector 30 may be provided with a variety of end connections for installation into a fluid system, including, for example, tube fittings, tube ends (e.g., for welding or installation in a tube fitting), quick disconnect couplings, or zero clearance face seal fittings.

The inner tube 10 and outer conduit 20 may be provided in any combination of suitable materials. In an exemplary embodiment, the inner tube 10 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 10 may additionally include a reinforcement layer 15, such as, for example, an outer braided material (e.g., metallic or fibrous braid material) secured to the inner tube. In other embodiments (not shown), a reinforcement material (e.g., a braided material) may additionally or alternatively be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimizing radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer conduit 20 comprises a metal material, such as stainless steel, Hastelloy C-22, or Monel, which may be selected based on gas impermeability, external corrosion resistance, flexibility, weldability, or other factors. The outer conduit 20 may be sized to provide a radial gap between the inner tube 10 and the outer conduit 20, for example, to provide clearance and ease of insertion of the inner tube into the outer conduit during assembly. While the radial gap may be minimized to minimize the outer diameter of the hose assembly (e.g., for efficient storage and routing), in other embodiments, a larger radial gap may be provided between the inner tube and the outer conduit to allow for the inclusion of radiant barrier material, insulation material, sensors (e.g., thermocouples, strain gauges), and/or other such materials or components (represented schematically at 50 in FIG. 1).

Many different types of attachment may be made between the connector 30 and the inner tube 10. In the illustrated embodiment, the distal end 11 of the inner tube 10 is compressed against a retaining portion or stem portion 35 of the connector 30, for example, by crimping or other such compressive deformation of the collar 40 against the inner tube distal end 11. In still other embodiments (not shown), the connector stem portion may additionally or alternatively be flared or expanded against the inner diameter of the inner tube distal end.

In the schematically illustrated embodiment of FIG. 1, a distal end 41 of the collar 40 extends over a flange portion or stem flange 37 of the connector 30, extending radially outward and axially rearward of the stem portion 35. An intermediate portion 44 of the collar 40 is compressed or crimped radially inward against the outer surface of the inner tube 10 (e.g., against the reinforcement layer 15) to compress the distal end 11 of the inner tube 10 into secure gripping engagement with the stem portion 35. Likewise, the distal end portion 41 of the collar 40 is compressed or crimped radially inward against the stem flange 37 for staked, interlocking engagement of the collar with the connector 30.

Where the outer tube is utilized to provide a leak-tight, gas-impermeable shell or sheath around a gas permeable inner tube, gas impermeable connections between the outer tube and the connector may be provided. While many different types of attachments may be made between the outer conduit 20 and the connector 30, in one embodiment, a weld connection is provided between the outer conduit and a body portion 33 of the connector to provide a leak-tight, gas impermeable connection between the outer tube and the connector. To provide for a welded connection, the outer tube 20 and connector 30 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

In the schematically illustrated embodiment of FIG. 1, the connector includes a second flange portion or body flange 39 extending radially outward and axially rearward of the stem flange 37. The body flange 39 is positioned to abut with the outer conduit distal end 21, such that the outer conduit distal end may be welded (e.g., butt weld, orbital weld) to the body flange.

The welded metal arrangement of the outer conduit 20 and connector 30 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 10 (e.g., having a gas permeability of greater than about 1×10⁴ scc/sec, or between about 1×10⁻³ scc/sec and about 1×10⁻² scc/sec).

In some embodiments, the outer conduit may be formed from a unitary metal tube, with a distal end portion of the tube attached directly (e.g., welded) to the connector.

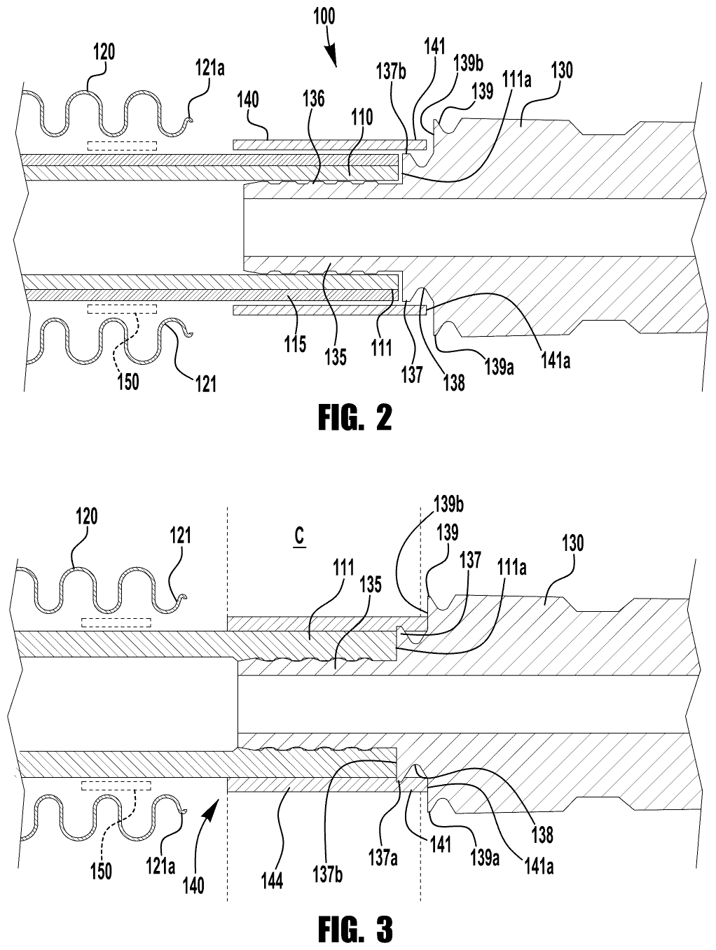

FIGS. 2, 3, and 4 illustrate exemplary embodiments of a hose 100 including an inner tube 110, an outer conduit 120, a connector 130 secured to distal ends 111, 121 of the inner tube and outer tube, and a collar 140 surrounded by the outer tube and in radial compression against the inner tube distal end 111 and the connector to secure the inner tube in sealing retention with the connector.

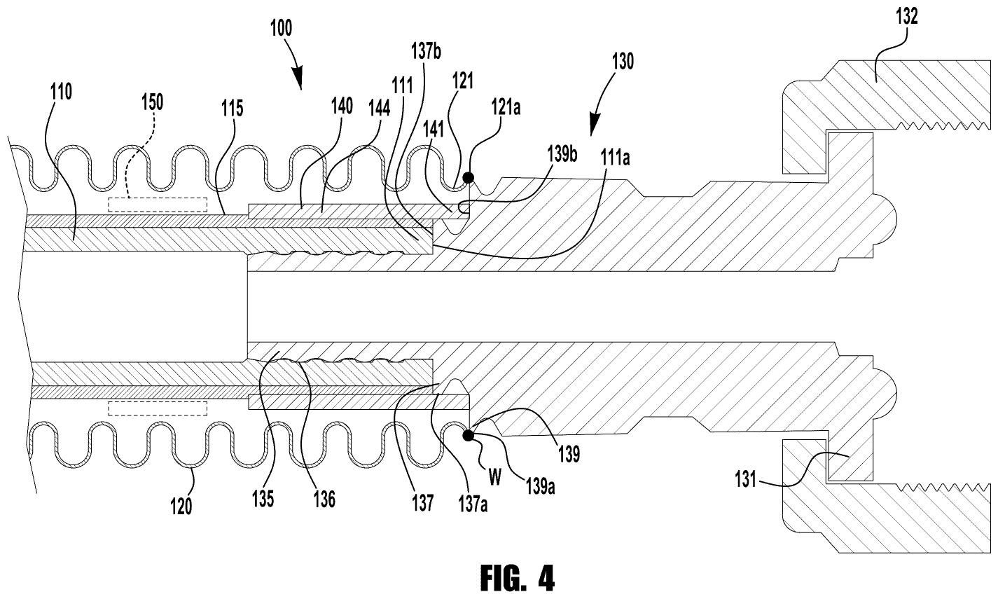

The connector 130 may be provided with a variety of end connections for installation into a fluid system, including, for example, tube fittings, tube ends (e.g., for welding or installation in a tube fitting), quick disconnect couplings, or zero clearance face seal fittings. As shown in FIG. 4, the connector 130 may include an integral or welded face seal flange 131, and may be sized to receive a face seal fitting nut 132 over the length of the connector and against the face seal flange 131, such that the nut 132 may be preassembled with the connector 130 prior to installation of the connector on the hose, without requiring additional welding (e.g., welding a gland with captured nut to the connector).

The inner tube 110 and outer conduit 120 may be provided in any combination of suitable materials. In an exemplary embodiment, the inner tube 110 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 110 may additionally include a reinforcement layer 115, such as, for example, an outer braided material (e.g., metallic or fibrous braid material) secured to the inner tube. In other embodiments (not shown), a reinforcement material (e.g., a braided material) may additionally or alternatively be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimized radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer conduit 120 comprises a metal material, such as stainless steel, Hastelloy C-22, or Monel, which may be selected based on gas impermeability, external corrosion resistance, flexibility, or other factors. While the outer tube may be provided in any suitable form, in the illustrated embodiment, the outer conduit 120 is a unitary corrugated wall metal tube 125, for example, to provide increased flexibility. In other embodiments, the outer tube may be helical or of some other suitable construction. The outer tube 125 may be sized to provide a radial gap between the inner tube 110 and the outer tube 125, for example, to provide clearance and ease of insertion of the inner tube into the outer tube during assembly. While the radial gap may be minimized to minimize the outer diameter of the hose assembly (e.g., for efficient storage and routing), in other embodiments, a larger radial gap may be provided between the tubes to allow for the inclusion of radiant barrier material, insulation material, sensors (e.g., thermocouples, strain gauges), and/or other such materials or components (represented schematically at 150 in FIGS. 2, 3, and 4).

While many different types of attachment may be made between the connector 130 and the inner tube 110, in the illustrated embodiment, the connector 130 includes a stem portion 135 received in the distal end 111 of the inner tube. As shown, the stem portion 135 may include a barbed surface 136 configured to grippingly engage the interior surface of the inner tube distal end 111. In some embodiments, secure attachment of the inner tube 110 to the connector 130 may be achieved by press fit installation of the connector stem portion. In the illustrated embodiment, the distal end 111 of the inner tube 110 may be compressed against the stem portion 135, for example, by crimping or other such compressive deformation of the collar 140 against the inner tube distal end 111. In still other embodiments (not shown), the connector stem portion may additionally or alternatively be flared or expanded against the inner diameter of the inner tube distal end.

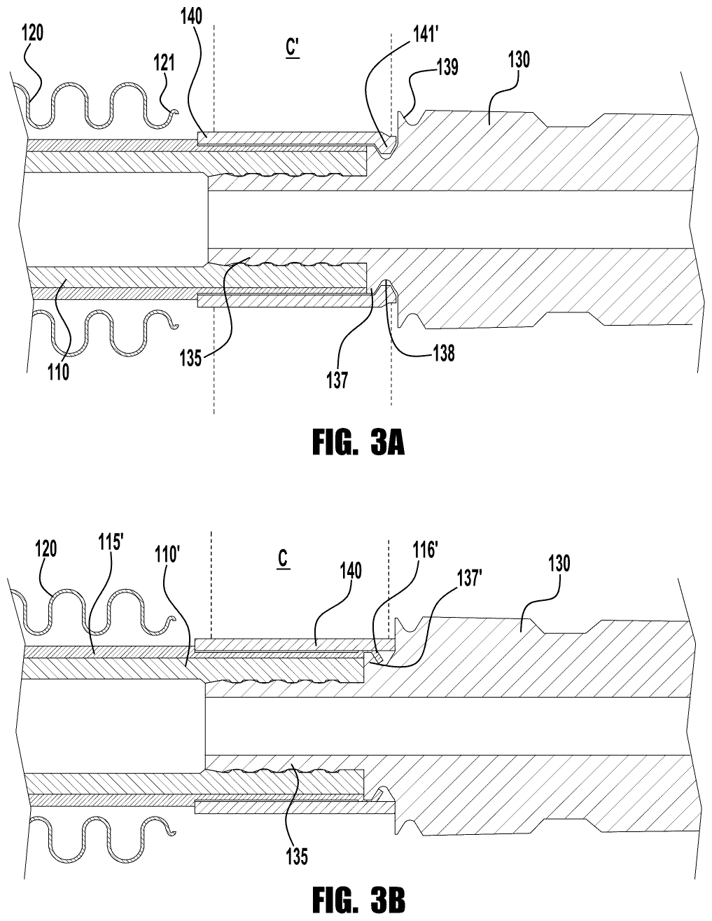

FIG. 2 illustrates the inner tube 110, outer conduit 120, connector 130, and collar 140 in a preassembled condition, with the collar in a pre-crimped condition. As shown, a distal end 141 of the collar 140 may be slipped over a flange portion or stem flange 137 of the connector 130, extending radially outward and axially rearward of the connector stem portion 135. As shown in FIG. 3, an intermediate portion 144 of the collar 140 is compressed or crimped radially inward (e.g., by crimping tool C) against the outer surface of the inner tube 110 (e.g., against the reinforcement layer 115) to compress the distal end 111 of the inner tube 110 into secure gripping engagement with the barbed stem portion 135. Likewise, the distal end portion 141 of the collar 140 is compressed or crimped radially inward against the stem flange 137 for staked, interlocking engagement of the collar with the connector 130. The collar 140 may be uniformly crimped or deformed radially inward along its length, with a biting edge 137a of the stem flange 137 embedding or indenting into the inner surface of the collar to axially secure the collar on the connector 130. In other embodiments, as shown in FIG. 3A, the distal end 141′ of the collar 140 may be crimped or deformed radially inward beyond the intermediate portion 144 (e.g., by crimping tool C′), into a recess 138 rearward of the stem flange 137, between the stem flange and a body portion 133 of the connector 130 to secure the collar against axial withdrawal.

As shown, the stem flange 137 may define a radial surface 137b positioned to align with at least a portion of the inner tube 110. In some embodiments, the inner tube 110 may be properly installed over the stem portion 135 of the connector 130 by advancing an end face 111a of the inner tube into abutment with the radial surface 137b of the flange portion 137. In other embodiments, a gauging tool (not shown) may be used (e.g., engaged with an exterior groove or step in the connector) to gauge proper installation of the inner tube over the connector stem portion.

In some embodiments, as shown in FIG. 3B, the stem flange 137′ may be sized to permit a distal end 116′ the outer reinforcement layer 115 of the inner tube 110′ to extend over the flange portion, such that when the collar distal end 141 is deformed radially inward against the stem flange 137, the reinforcement layer end (e.g., ends of the braided material) is captured between the collar distal end and the flange portion, for example, to provide a more robust attachment of the connector and/or to increase the potential working pressure of the hose.

While the collar may be provided in a variety of structures and geometries, in the illustrated embodiment, the collar 140 is provided as a substantially tubular section, at least prior to deformation, for example, for cost efficiency, ease of manufacture, and ease of installation over the inner tube 110 and stem flange 137. The collar 140 may be provided with a substantially smooth internal bore, or with a roughened, knurled, or discontinuous (e.g., ribbed, toothed) internal surface, for example, to enhance gripping of the collar against the inner tube or flange portion.

Where the outer conduit is utilized to provide a leak-tight, gas-impermeable shell or sheath around a gas permeable inner tube, gas impermeable connections between the outer tube and the connector may be provided. While many different types of attachments may be made between the outer conduit 120 and the connector 130, in one embodiment, a weld connection is provided between the corrugated outer tube 125 and the connector to provide a leak-tight, gas impermeable connection between the outer tube and the connector. To provide for a welded connection, the outer tube 125 and connector 130 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

Many different types of weld connections may be utilized. In the illustrated embodiments of FIGS. 2-4, the body portion 133 of the connector 130 includes a second flange portion or body flange 139 extending radially outward and axially rearward of the first flange portion 137. The body flange 139 is positioned to abut with the outer tube distal end 121, such that the outer tube distal end may be welded (e.g., butt welded, orbital welded) to the second flange portion (FIG. 4). In the illustrated embodiment, the second flange portion 139 defines a relatively thin annular rib 139a. The outer tube distal end 121 may be prepared (e.g., using a pipe cutter wheel) such that the truncated corrugated edge 121a of the distal end forms a lip that radially aligns with the annular rib 139a, for welding of the rib and lip portions (FIG. 4).

As shown, the second flange portion 139 may define a radial surface 139b positioned to align with at least a portion of the collar 140. In some embodiments, the collar 140 may be properly installed over the first flange portion 137 of the connector 130 by advancing an end face 141a of the collar into abutment with the radial surface 139b of the second flange portion 139. In other embodiments, a gauging tool (not shown) may be used (e.g., engaged with an exterior groove or step in the connector) to gauge proper installation of the inner tube over the connector stem portion.

The welded metal arrangement of the corrugated outer tube 225 and connector 230 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 210 (e.g., having a gas permeability of greater than about 1×10⁴ scc/sec, or between about 1×10⁻³ scc/sec and about 1×10⁻² scc/sec).

In an exemplary method of making a hose assembly, a distal end 111 of an inner tube 110 carrying a loosely assembled inner collar 140 and surrounding outer tube 125 is installed over a stem portion 135 of a connector 130, with an end face 111a of the inner tube axially advanced into abutment with a radial surface 137b of the first flange portion 137 of the connector, as shown in FIG. 2. With the outer tube 125 terminating at a location axially spaced apart from the connector 130 (e.g., with the corrugations of the outer tube axially compressed), the collar 140 is axially advanced over the inner tube distal end 111 and over the first flange portion 137, with an end face 141a of the collar advanced into abutment with a radial surface 139b of a second flange portion 139. A crimping tool C is applied to the collar 140 to radially compress an intermediate portion 144 of the collar 140 against the inner tube 110, and a distal portion 141 of the collar 140 against the first flange portion 137 of the connector (e.g., against a biting edge 137a of the first flange portion), as shown in FIG. 3. A distal end 121 of the outer tube 125 is axially moved over the inner tube distal end 111, the collar 140, and the first flange portion 137 (e.g., by axially expanding the outer tube corrugations), and into engagement with the second flange portion 139, with a lip portion 121a of the outer tube distal end 121 radially aligning with and abutting an annular rib portion 139a of the second flange portion, and the lip portion 121a is welded to the rib portion 139a at weld location W, as shown in FIG. 4.

According to another aspect of the present disclosure, in some applications, an outer conduit of a hybrid hose assembly may include multiple conduit elements joined (e.g., welded) to form the outer conduit, for example, to facilitate assembly of the hybrid hose (e.g., without requiring axial compression or deformation of a corrugated tube to expose the internal, inner tube compressing collar for crimping). Referring back to the schematically illustrated hose 5 of FIG. 1, the outer conduit may include an outer tube 25 and an outer collar 24, with a distal end portion 22 of the outer tube welded to a proximal end portion 28 of the outer collar, and a distal end portion 21 of the outer collar welded to the connector 30. In one such exemplary arrangement, an outer conduit may include a corrugated metal tube and a metal outer collar, with a distal end of the corrugated metal tube welded to a proximal end of the outer collar, and a distal end of the outer collar welded to the connector.

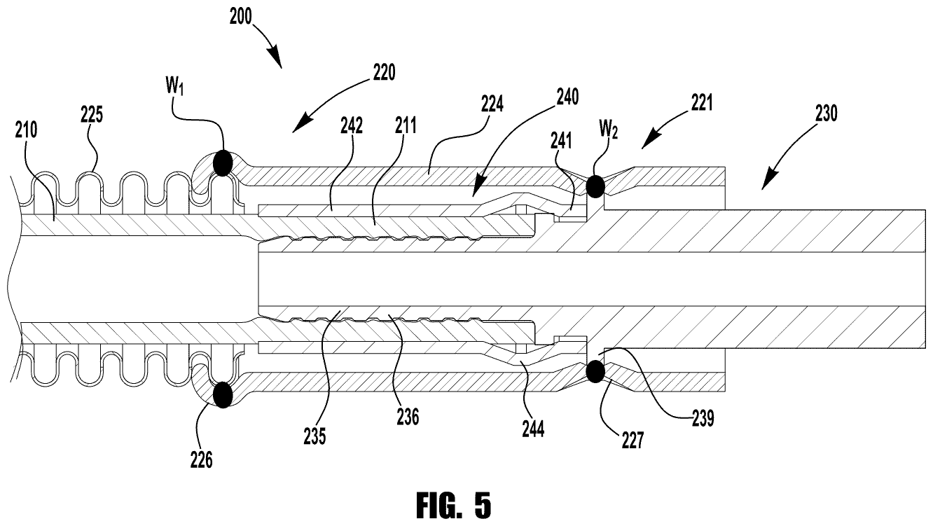

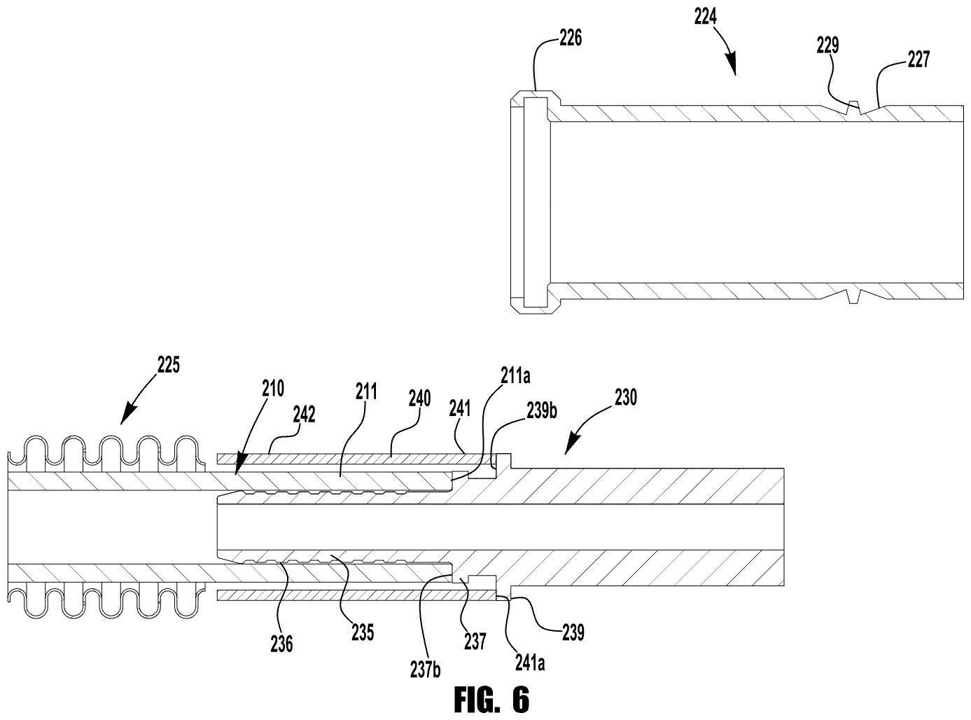

FIGS. 5-8 illustrate an exemplary embodiment of a hose 200 including an inner tube 210, an outer conduit 220 formed from a corrugated metal tube 225 and an outer collar 224, a connector 230 secured to distal ends 211, 221 of the inner tube and outer collar, and an inner collar 240 surrounded by the outer conduit 220 (e.g., by the outer collar 224) and in radial compression against the inner tube distal end 211 and the connector to secure the inner tube in sealing retention with the connector.

The connector 230 may be provided with a variety of end connections for installation into a fluid system, including, for example, tube fittings, tube ends (e.g., for welding or installation in a tube fitting), quick disconnect couplings, or zero clearance face seal fittings, as described above.

The inner tube 210 and outer conduit 220 may be provided in any combination of suitable materials, including, for example, the materials and constructions of the inner tube 110 and outer conduit 120 of the hose 100 of FIGS. 2-4, as described above, including, for example, a reinforcement material (e.g. braided metal sheath) provided on or in a plastic inner tube (not shown).

While many different types of attachment may be made between the connector 240 and the inner tube 220, in the illustrated embodiment, the connector 230 includes a stem portion 235 received in the distal end 211 of the inner tube. As shown, the stem portion 235 may include a barbed surface 236 configured to grippingly engage the interior surface of the inner tube distal end 211. In some embodiments, secure attachment of the inner tube 210 to the connector 230 may be achieved by press fit installation of the connector stem portion. In the illustrated embodiment, the distal end 211 of the inner tube 210 may be compressed against the stem portion 235, for example, by crimping or other such compressive deformation of the inner collar 240 against the inner tube distal end 211. In still other embodiments (not shown), the connector stem portion may additionally or alternatively be flared or expanded against the inner diameter of the inner tube distal end.

FIG. 6 illustrates the inner tube 210, outer tube 225, outer collar 224, connector 230, and inner collar 240 in a preassembled condition, with the inner collar in an uncrimped condition and the outer collar not yet welded to the outer metal tube. As shown, the inner collar 240 may be slipped over a portion of the inner tube 210 extending beyond the outer metal tube 225. The barbed stem portion 235 of the connector 230 may then be inserted into the inner tube 210, with a distal end portion of the inner collar 240 extending over a flange portion or stem flange 237 of the connector 230.

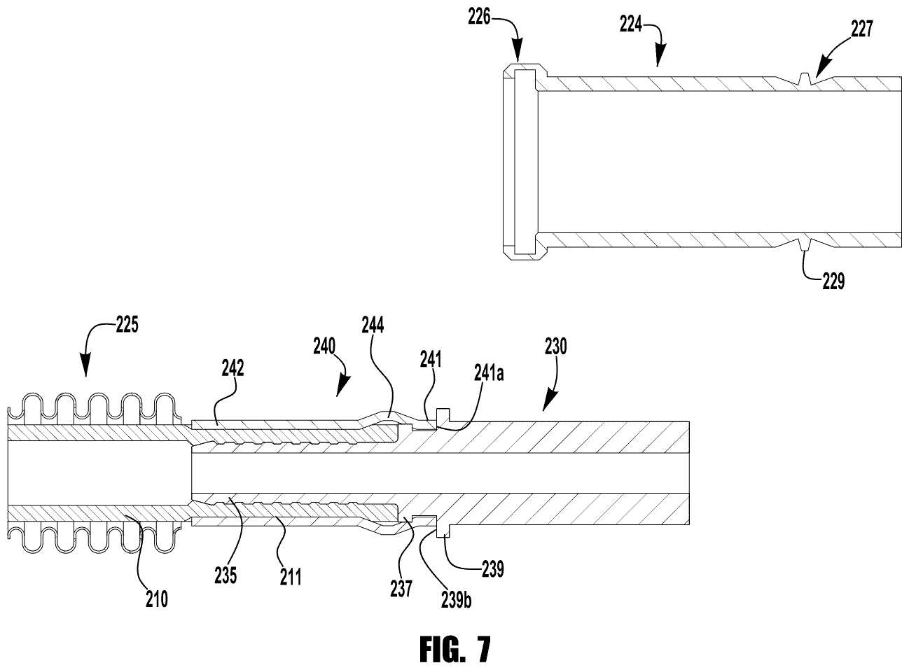

As shown in FIG. 7, a proximal portion 242 of the inner collar 240 is compressed or crimped radially inward (e.g., by crimping tool) against the outer surface of the inner tube 210 (e.g., against an outer reinforcement layer) to compress the distal end 211 of the inner tube 210 into secure gripping engagement with the barbed stem portion 235, and a distal portion 241 of the inner collar is compressed or crimped radially inward (e.g., by crimping tool) against the stem flange 237 for staked, interlocking engagement of the inner collar with the connector 230. An intermediate portion 244 of the inner collar 240 may remain uncrimped or less compressed, for example, to provide space for the plastic inner tube 210 to flow upon compression. In other embodiments (not shown, but may be similar to the embodiment of FIG. 3A), the distal end of the inner collar may be crimped or deformed radially inward into a recess rearward of the stem flange, between the stem flange and a body portion of the connector to secure the collar against axial withdrawal.

As shown, the second flange portion 239 may define a radial surface 239b positioned to align with at least a portion of the inner collar 240. In some embodiments, the inner collar 240 may be properly installed over the first flange portion 237 of the connector 230 by advancing an end face 241a of the collar into abutment with the radial surface 239b of the second flange portion 239. In other embodiments, a gauging tool (not shown) may be used (e.g., engaged with an exterior groove or step in the connector) to gauge proper installation of the inner tube over the connector stem portion.

As shown, the stem flange 237 may define a radial surface 237b positioned to align with at least a portion of the inner tube 210. In some embodiments, the inner tube 210 may be properly installed over the stem portion 235 of the connector 230 by advancing an end face 211a of the inner tube into abutment with the radial surface 237b of the flange portion 237. In other embodiments, a gauging tool (not shown) may be used (e.g., engaged with an exterior groove or step in the connector) to gauge proper installation of the inner tube over the connector stem portion.

In some embodiments (not shown, but may be similar to the embodiment of FIG. 3B), the stem flange may be sized to permit a distal end of the outer reinforcement layer of the inner tube to extend over the flange portion, such that when the collar distal end is deformed radially inward against the stem flange, the reinforcement layer end (e.g., ends of the braided material) is captured between the collar distal end and the flange portion, for example, to provide a more robust attachment of the connector and/or to increase the potential working pressure of the hose.

While the inner collar may be provided in a variety of structures and geometries, in the illustrated embodiment, the inner collar 240 is provided as a substantially tubular section, at least prior to deformation, for example, for cost efficiency, ease of manufacture, and ease of installation over the inner tube 210 and stem flange 237. The inner collar 240 may be provided with a substantially smooth internal bore, or with a roughened, knurled, or discontinuous (e.g., ribbed, toothed) internal surface, for example, to enhance gripping of the collar against the inner tube or flange portion.

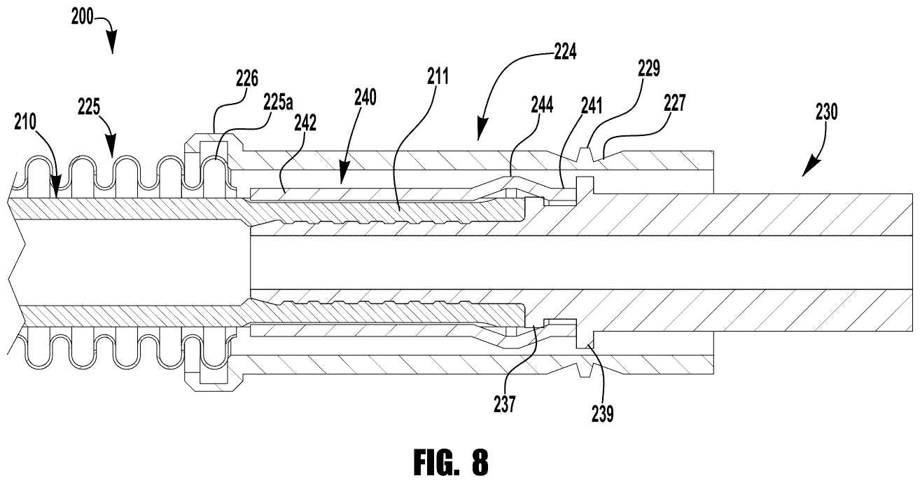

As shown in FIG. 8, the outer collar 224 may then be slipped over the connector 230, with a proximal hook portion 226 aligning with and shaped to engage an endmost corrugation 225a of the metal tube 225 and a thinned down weld region 227 aligning with a distal flange 239 of the connector 230. As shown in FIG. 5, the hook portion 226 may then be crimped into radial engagement with the endmost corrugation 225a, and the weld region 227 crimped into radial engagement with the distal flange 239, for welding (e.g., orbital welding) at the two weld locations W1, W2. In some arrangements, the weld region 227 of the weld collar may (but need not) include an enlarged rib 229 providing sacrificial weld material to facilitate formation of the autogenous weld. This enlarged rib 229 may further facilitate weld positioning or component alignment. In other embodiments, the welded assembly may use a filler material. Further, the welding operation may involve movement of the weld electrode around the weld collar (i.e., an orbital weld), or rotation of the workpiece components proximate a stationary electrode.

The welded metal arrangement of the corrugated outer tube 225, outer collar 224, and connector 230 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 110 (e.g., having a gas permeability of greater than about 1×10⁴ scc/sec, or between about 1×10⁻³ scc/sec and about 1×10⁻² scc/sec).

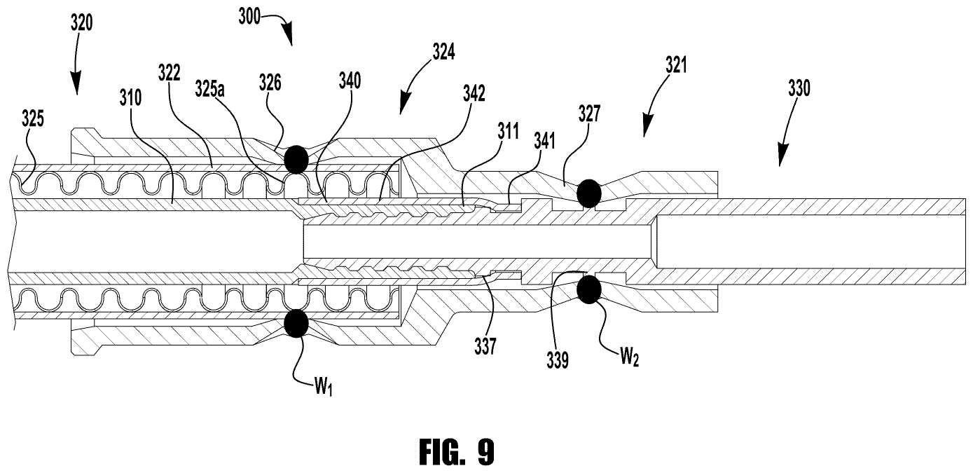

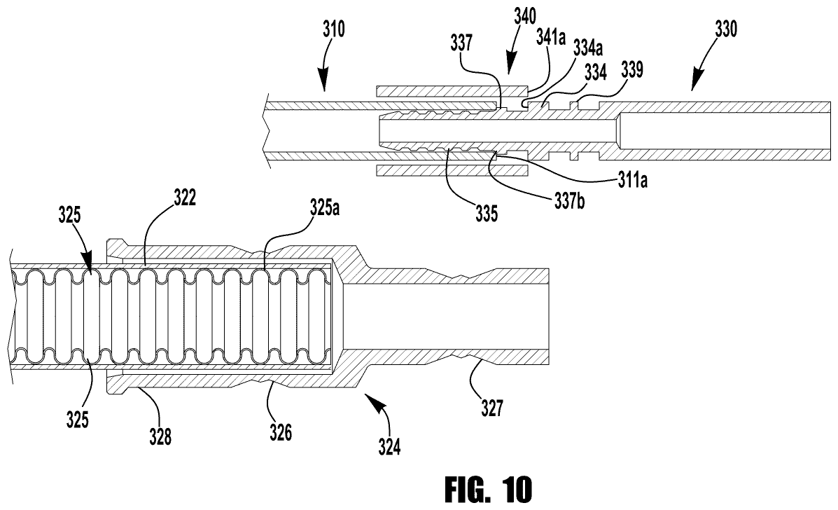

In other embodiments, a proximal end of an outer collar may include a proximal thinned down weld region welded to a distal end of a metal tube to form an outer conduit for a hybrid hose assembly. FIGS. 9-12 illustrate an exemplary embodiment of a hose 300 including an inner tube 310, an outer conduit 320 formed from a corrugated metal tube 325 and an outer collar 324, a connector 330 secured to distal ends 311, 321 of the inner tube and outer collar, and an inner collar 340 surrounded by the outer conduit 320 (e.g., by the outer collar 324) and in radial compression against the inner tube distal end 311 and the connector to secure the inner tube in sealing retention with the connector. These components may (but need not) be similar to or consistent with those of the hoses 5, 100, 200 described above, and have been numbered accordingly.

The inner tube 310 and outer conduit 320 may be provided in any combination of suitable materials, including, for example, the materials and constructions of the inner tube 110 and outer conduit 120 of the hose 100 of FIGS. 2-4, as described above, including, for example, a reinforcement material (e.g. braided metal sheath) provided on or in a plastic inner tube (not shown).

FIG. 10 illustrates the inner tube 310, outer tube 325, outer collar 324, connector 330, and inner collar 240 in a preassembled condition, with the inner collar in a pre-crimped condition and the outer collar 324 not yet welded to the outer metal tube 325. As shown, the inner collar 340 may be slipped over the distal portion 311 of the inner tube 310. The barbed stem portion 335 of the connector 330 is inserted into the inner tube 310, with a distal end portion 341 of the inner collar 340 extending over a proximal flange or stem flange 337 of the connector 330.

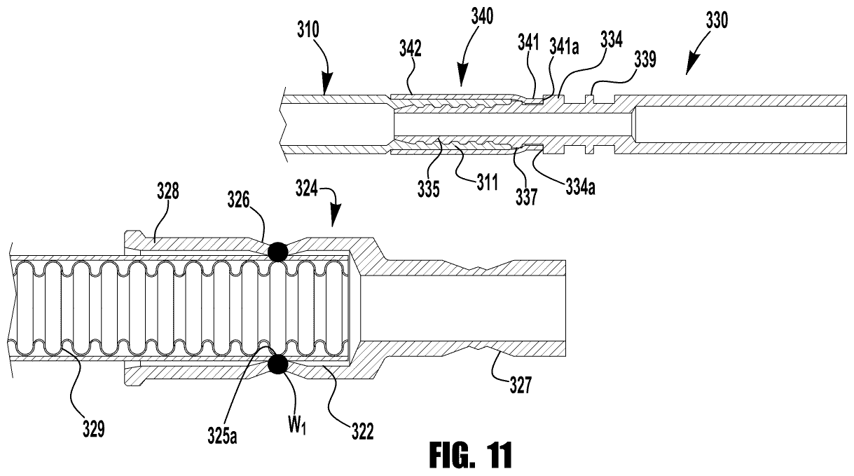

As shown in FIG. 11, a proximal portion 342 of the inner collar 340 is compressed or crimped radially inward (e.g., by crimping tool) against the outer surface of the inner tube 310 (e.g., against an outer reinforcement layer) to compress the distal end 311 of the inner tube 310 into secure gripping engagement with the barbed stem portion 335, and a distal portion 341 of the inner collar is compressed or crimped radially inward (e.g., by crimping tool) against the stem flange 337 for staked, interlocking engagement of the inner collar with the connector 330. An intermediate portion of the inner collar may remain uncrimped or less compressed (not shown, but may be similar to the embodiment of FIG. 5), for example, to provide space for the plastic inner tube 310 to flow upon compression. In other embodiments (not shown, but may be similar to the embodiment of FIG. 3A), the distal end of the inner collar may be crimped or deformed radially inward into a recess rearward of the stem flange, between the stem flange and a body portion of the connector to secure the collar against axial withdrawal.

As shown, an intermediate flange 334 between the proximal stem flange 337 and a distal flange 339 may define a radial surface 334a positioned to align with at least a portion of the inner collar 240. In some embodiments, the inner collar 240 may be properly installed over the first flange portion 337 of the connector 330 by advancing an end face 341a of the collar into alignment or abutment with the radial surface 334a of the intermediate flange 334. In other embodiments, a gauging tool (not shown) may be used (e.g., engaged with an exterior groove or step in the connector) to gauge proper installation of the inner tube over the connector stem portion.

As shown, the stem flange 337 may define a radial surface 337b positioned to align with at least a portion of the inner tube 310. In some embodiments, the inner tube 310 may be properly installed over the stem portion 335 of the connector 330 by advancing an end face 311a of the inner tube into abutment with the radial surface 337b of the flange portion 337 (FIG. 10). In other embodiments, a gauging tool (not shown) may be used (e.g., engaged with an exterior groove or step in the connector) to gauge proper installation of the inner tube over the connector stem portion.

In some embodiments (not shown, but may be similar to the embodiment of FIG. 3B), the stem flange may be sized to permit a distal end of the outer reinforcement layer of the inner tube to extend over the flange portion, such that when the collar distal end is deformed radially inward against the stem flange, the reinforcement layer end (e.g., ends of the braided material) is captured between the collar distal end and the flange portion, for example, to provide a more robust attachment of the connector and/or to increase the potential working pressure of the hose.

While the inner collar may be provided in a variety of structures and geometries, in the illustrated embodiment, the inner collar 340 is provided as a substantially tubular section, at least prior to deformation, for example, for cost efficiency, ease of manufacture, and ease of installation over the inner tube 310 and stem flange 337. The inner collar 340 may be provided with a substantially smooth internal bore, or with a roughened, knurled, or discontinuous (e.g., ribbed, toothed) internal surface, for example, to enhance gripping of the collar against the inner tube or stem flange.

In some implementations, the outer collar 324 may be welded to the metal tube 325 before the inner tube 310 is installed within the outer tube, for example, to avoid exposure of the inner tube to heat from the outer tube—outer collar welding operation. In such an arrangement, the proximal end portion 328 of the outer collar 324 is slipped over the outer tube 325 such that a thinned down proximal weld region 326 of the outer collar aligns with a portion (e.g., a corrugated crest portion 325a) of the outer tube. The proximate weld region 326 is then crimped radially inward against the outer tube portion 325a for welding at a proximal weld location W1 (FIG. 11). As shown, a metal outer sheath 322 (e.g., braided metal sheath) may be provided over the corrugated outer tube 325 and captured between the crimped proximal weld region 326 and the outer tube, for weld penetration of the outer sheath 322 during the welding operation.

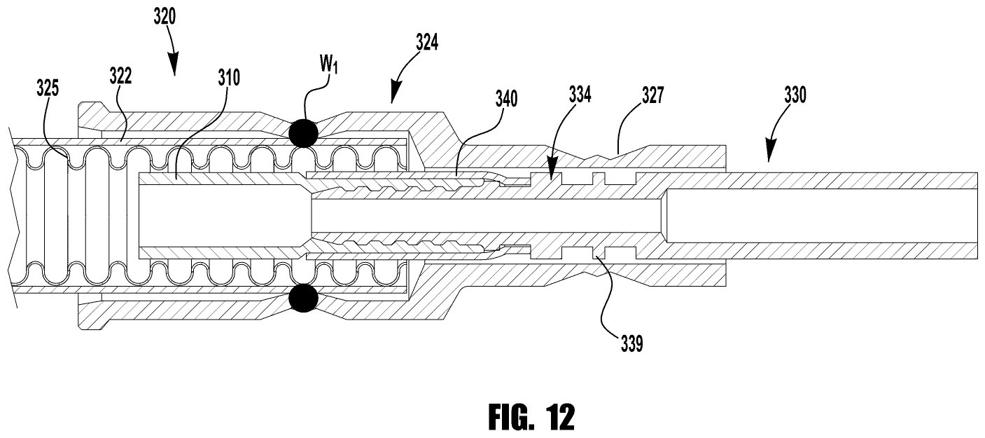

As shown in FIG. 12, the inner tube 310, inner collar 340, and proximal end of the connector 330 may then be inserted into the welded outer conduit subassembly 320, such that a thinned down distal weld region 327 aligns with the distal flange 339 of the connector 330.

As shown in FIG. 9, the distal weld region 327 may then be crimped into radial engagement with the distal flange 339, for welding (e.g., orbital welding) at a distal weld location W2, as shown in FIG. 10. In an exemplary arrangement, the distal weld region 327 of the weld collar may (but need not) include an enlarged rib 323 providing sacrificial weld material to facilitate formation of the autogenous weld. This enlarged rib 323 may further facilitate weld positioning or component alignment. In other embodiments, the welded assembly may use a filler material. Further, the welding operation may involve movement of the weld electrode around the weld collar (i.e., an orbital weld), or rotation of the workpiece components proximate a stationary electrode.

The welded metal arrangement of the corrugated outer tube 225, outer collar 224, and connector 230 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 110 (e.g., having a gas permeability of greater than about 1×10⁴ scc/sec, or between about 1×10⁻³ scc/sec and about 1×10⁻² scc/sec).

According to another aspect of the present disclosure, an outer conduit of a hybrid hose assembly may include an outer tube joined (e.g., welded) to a proximal end portion of a connector having an intermediate portion compressed or crimped against a distal end portion of an inner tube to compress the inner tube distal end portion between the collar and a stem portion of an anchor element received in the distal end of the connector. The distal end of the connector may include a fitting connection (e.g., a face seal fitting connection) for attachment to a mating fitting connection, for example, to facilitate removal and or replacement of the hose from a fluid system.

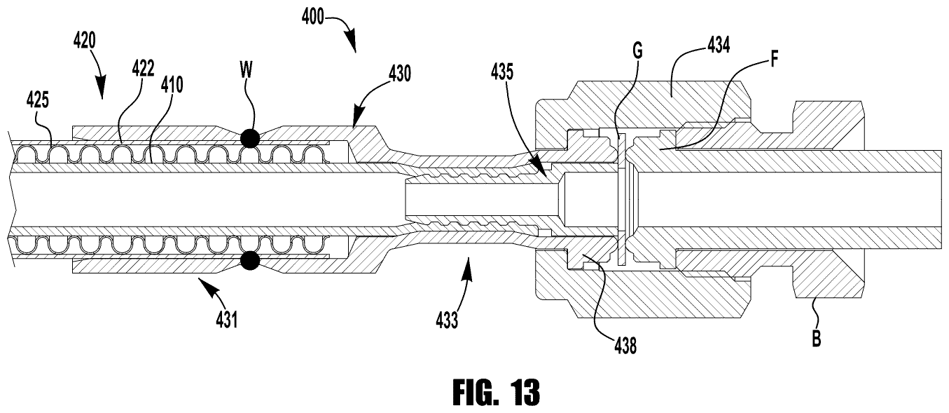

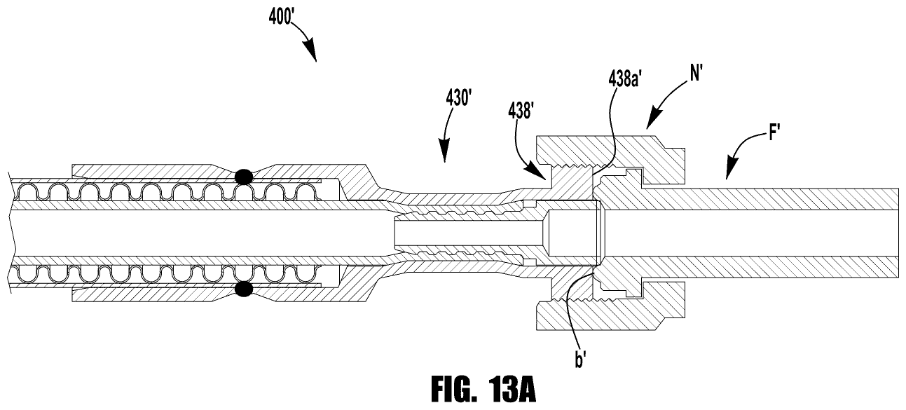

FIGS. 13-16 illustrate an exemplary embodiment of a hose 400 including an inner tube 410, an outer conduit 420 formed from a corrugated metal tube 425, a connector 430, and an anchor member 435. The connector 430 includes a proximal end portion 431 sized to closely receive the outer tube 425, an intermediate portion 433 sized to closely receive the distal end portion 411 of the inner tube 410, and a distal end portion including an end connection 438 (e.g., a face seal fitting connection), which may be sized to receive the anchor member 435.

The connector 430 may be provided with a variety of end connections for installation into a fluid system, including, for example, tube fittings, tube ends (e.g., for welding or installation in a tube fitting), quick disconnect couplings, or zero clearance face seal fittings, as described above. In the illustrated embodiment, the connector 430 is provided with a face seal gland 438 (e.g., VCR gland), with a captive or split nut 434 assembled or retained with the gland for assembly with a face seal coupling. The connector 430 may be connected with a fluid system, for example, to a mating face seal fluid system gland F by a coupler body B threadably engageable with the captive/split nut 434 for compressive face seal engagement of the face seal gland 438 and the fluid system gland F against a face seal gasket G.

In another embodiment, as shown in FIG. 13A, a hose 400′ includes a connector 430′ provided with a male threaded gland 438′, which may be coupled to a mating fluid system gland F′ by a female threaded nut N′. As shown, the male threaded gland 438′ may include a planar end face 438a′ for metal-to-metal sealing engagement with an annular bead b′ on the fluid system gland F′. In other embodiments (not shown), the male threaded gland may be provided with an annular bead and the fluid system gland may be provided with a planar end face.

The inner tube 410 and outer conduit 420 may be provided in any combination of suitable materials, including, for example, the materials and constructions of the inner tube 110 and outer conduit 120 of the hose 100 of FIGS. 2-4, as described above, including, for example, a reinforcement material (e.g. braided metal sheath) provided on or in a plastic inner tube (not shown).

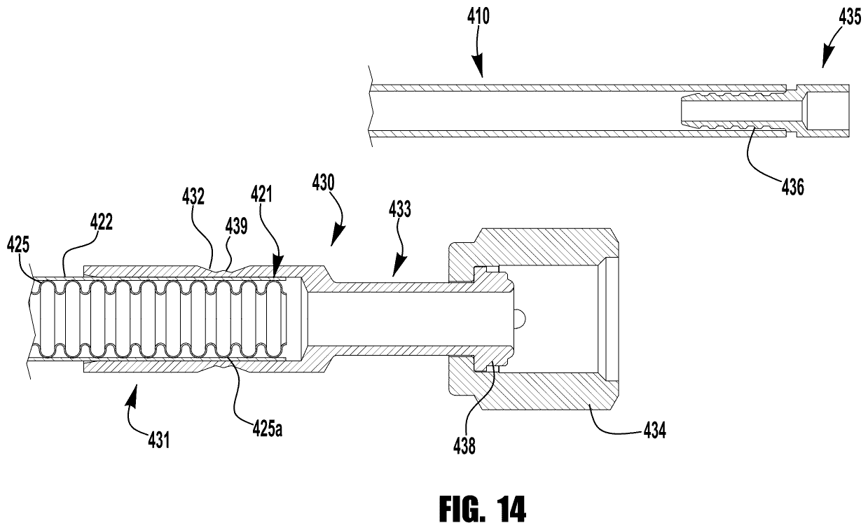

FIG. 14 illustrates the inner tube 410, outer tube 425, connector 430, and anchor member 435 in a preassembled condition, with the intermediate portion 433 of the connector in a pre-crimped condition and the proximal end portion 431 of the connector not yet welded to the outer metal tube.

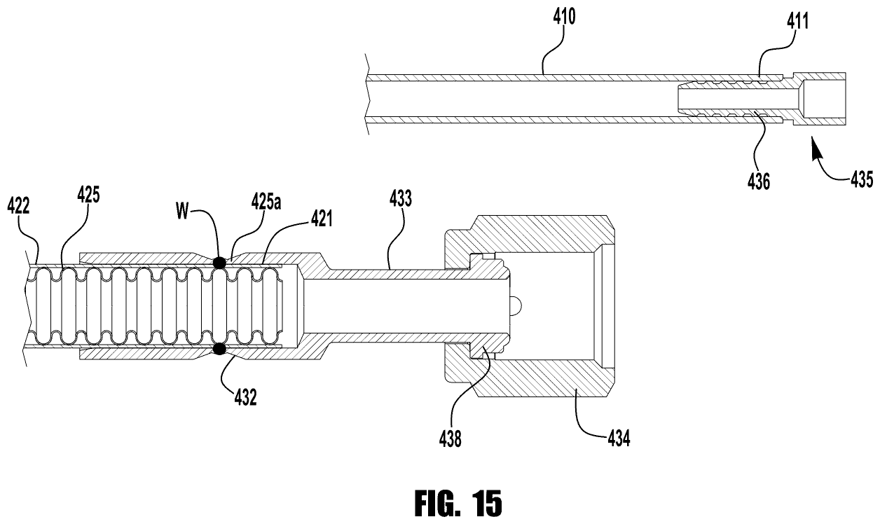

As shown in FIG. 15, the proximal end portion 431 of the connector 430 is slipped over the distal end portion 421 of the outer tube 425, such that a thinned down proximal weld region 432 of the connector aligns with a portion (e.g., a corrugated crest portion 425a) of the outer tube. The proximate weld region 432 is then crimped radially inward against the outer tube portion 425a for welding at a proximal weld location W. As shown, a metal outer sheath 422 (e.g., braided metal sheath) may be provided over the corrugated outer tube 425 and captured between the crimped proximal weld region 432 and the outer tube, for weld penetration of the outer sheath 422 during the welding operation. In such an arrangement, the weld region 432 of the connector 430 may (but need not) include an enlarged rib 439 providing sacrificial weld material to facilitate formation of the autogenous weld. This enlarged rib 439 may further facilitate weld positioning or component alignment. In other embodiments, the welded assembly may use a filler material. Further, the welding operation may involve movement of the weld electrode around the weld collar (i.e., an orbital weld), or rotation of the workpiece components proximate a stationary electrode.

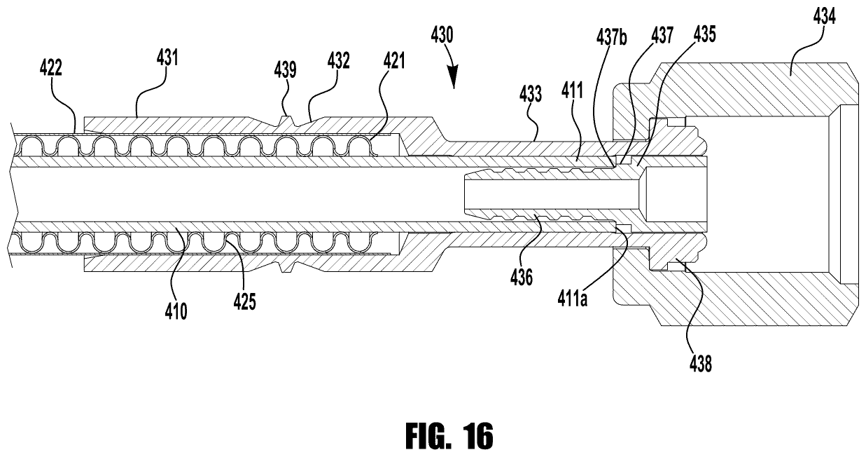

As shown in FIG. 16, the inner tube 410 and anchor member 435 (with barbed stem portion 436 already inserted into the inner tube distal end 411) may then be inserted into the distal end portion or gland 438 of the connector 430, such that the inner tube distal end and barbed stem portion align with the intermediate portion 433 of the connector.

As shown, a flange portion 437 of the anchor member 435 may define a radial surface 437b positioned to align with at least a portion of the inner tube 410. In some embodiments, the inner tube 410 may be properly installed over the stem portion 436 of the anchor member 435 by advancing an end face 411a of the inner tube into abutment with the radial surface 437b of the flange portion 437. In other embodiments, a gauging tool (not shown) may be used (e.g., engaged with an exterior groove or step in the connector) to gauge proper installation of the inner tube over the connector stem portion.

As shown in FIG. 13, the intermediate portion 433 of the connector 430 is then compressed or crimped radially inward (e.g., by crimping tool) against the outer surface of the inner tube 410 (e.g., against an outer reinforcement layer) to compress the distal end 411 of the inner tube 410 into secure gripping engagement with the barbed stem portion 436 of the anchor member 435.

A portion of the connector intermediate portion 433 may remain uncrimped or less compressed (not shown), for example, to provide space for the plastic inner tube 410 to flow upon compression. In other embodiments (not shown, but may be similar to the embodiment of FIG. 3A), the distal end of the inner collar may be crimped or deformed radially inward into a recess rearward of the stem flange, between the stem flange and a body portion of the connector to secure the collar against axial withdrawal.

In some embodiments (not shown, but may be similar to the embodiment of FIG. 3B), the stem flange may be sized to permit a distal end of the outer reinforcement layer of the inner tube to extend over the flange portion, such that when the collar distal end is deformed radially inward against the stem flange, the reinforcement layer end (e.g., ends of the braided material) is captured between the collar distal end and the flange portion, for example, to provide a more robust attachment of the connector and/or to increase the potential working pressure of the hose.

The connector intermediate portion 433 may be provided with a substantially smooth internal bore, or with a roughened, knurled, or discontinuous (e.g., ribbed, toothed) internal surface, for example, to enhance gripping of the collar against the inner tube or flange portion.

The welded metal arrangement of the corrugated outer tube 425, outer collar 424, and connector 430, 430′, and the face seal fitting connection between the connector gland 438, 438′ and the mating fluid system gland F, F′ may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 410 (e.g., having a gas permeability of greater than about 1×10⁻⁴ scc/sec, or between about 1×10⁻³ scc/sec and about 1×10⁻² scc/sec).

According to another aspect of the present disclosure, in some applications, for example, applications involving lower pressure systems (e.g., less than about 200 psi), a hybrid hose assembly may utilize an external crimped collar having a first end welded to a distal end of the outer metal tube, and a second end crimped against the inner tube without being welded to the connector, instead relying on the length and compression of the inner tube against the inserted connector stem to provide permeation resistance at the distal end of the inner tube.

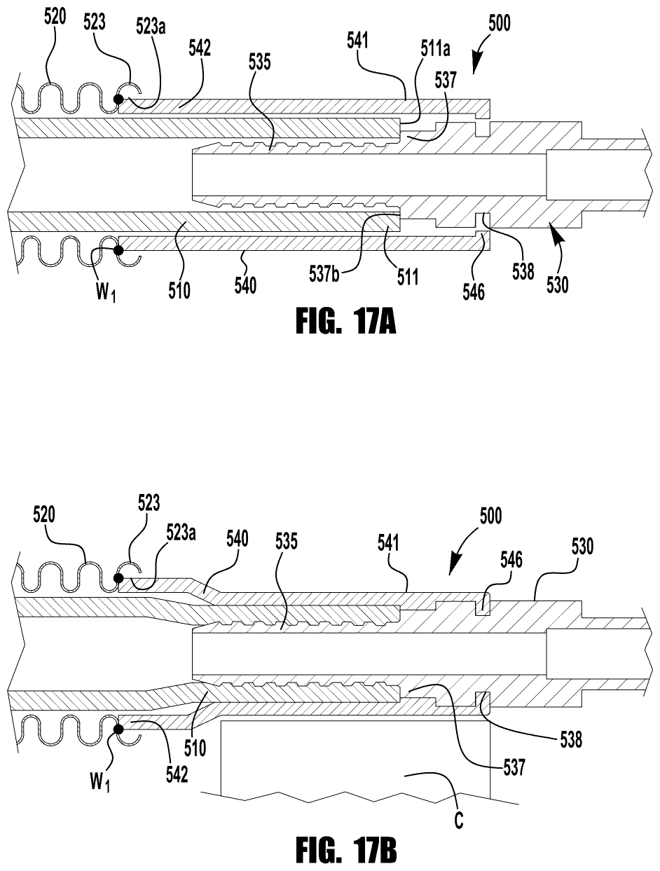

FIGS. 17A and 17B illustrate an exemplary embodiment of a hose 500 including an inner or core tube 510, an outer tube 520, a connector 530 secured to distal ends 511, 521 of the inner tube and outer tube, and a collar 540 in radial compression against the inner tube distal end 511 and the connector to secure the inner tube in sealing retention with the connector.

The connector 530 may be provided with a variety of end connections for installation into a fluid system, including, for example, tube fittings, tube ends (e.g., for welding or installation in a tube fitting), quick disconnect couplings, or zero clearance face seal fittings, as shown and described herein.

The inner tube 510 and outer tube 520 may be provided in any combination of suitable materials. In an exemplary embodiment, the inner tube 510 comprises a plastic material, such as polytetrafluoroethylene (PTFE) or perfluoroalkoxy alkane (PFA), which may be selected based on fluid system compatibility, gas impermeability, flexibility, or other factors. While the inner tube may be provided in any suitable form, in one embodiment, the inner tube is provided with a smooth cylindrical internal wall, for example, for ease of cleaning and to minimize particle entrapment. The inner tube 510 may additionally include a reinforcement layer (not shown), such as, for example, a braided material (e.g., metallic or fibrous braid material) secured to the inner tube. Inclusion of a reinforcement layer on the outer surface of the inner tube may present potential leak paths between the inner tube and the collar. Accordingly, in some embodiments (not shown), a reinforcement material (e.g., a braided material) may be secured to an interior surface of the inner tube, and/or embedded in the wall thickness of the inner tube. This reinforcement layer may provide many benefits, including, for example, prevention of kinking of the inner tube (particularly when subjected to a tighter bending radius), maintaining a smooth inside diameter as desired for fluid flow, and minimized radial and axial expansion. In an exemplary embodiment described herein, minimization of radial expansion may improve grip on the inner tube end by the connector stem (as described below), allowing the hose to withstand greater fluid pressures and axial pulling forces on the hose (e.g., due to abuse, system vibration, pulsing, or other factors).

In an exemplary embodiment, the outer tube 520 comprises a metal material, such as stainless steel, Hastelloy C-22, or Monel, which may be selected based on gas impermeability, external corrosion resistance, flexibility, or other factors. While the outer tube may be provided in any suitable form, in the illustrated embodiment, the outer tube 520 is provided with a corrugated wall, for example, for increased flexibility. In other embodiments, the outer tube may be helical or of some other suitable construction. The outer tube 520 may be sized to provide a radial gap between the inner tube 510 and the outer tube 520, for example, to provide clearance and ease of insertion of the inner tube into the outer tube during assembly. While the radial gap may be minimized to minimize the outer diameter of the hose assembly (e.g., for efficient storage and routing), in other embodiments, a larger radial gap may be provided between the tubes to allow for the inclusion of radiant barrier material, insulation material, sensors (e.g., thermocouples, strain gauges), and/or other such materials or components (similar to the components 50, 150 in FIGS. 1-4).

While many different types of attachment may be made between the connector 530 and the inner tube 510, in the illustrated embodiment, the connector 530 includes a stem portion 535 received in the distal end 511 of the inner tube. As shown, the stem portion 535 may include a barbed surface configured to grippingly engage the interior surface of the inner tube distal end 511. In some embodiments, secure attachment of the inner tube 510 to the connector 530 may be achieved by press fit installation of the connector stem portion. In the illustrated embodiment, the distal end 511 of the inner tube 510 may be compressed against the stem portion 535, for example, by crimping or other such compressive deformation of the collar 540 against the inner tube distal end 511. In still other embodiments (not shown), the connector stem portion may additionally or alternatively be flared or expanded against the inner diameter of the inner tube distal end.

FIG. 17A illustrates the inner tube 510, outer tube 520, connector 530, and collar 540 in a preassembled condition, with the collar in a pre-crimped condition. As shown, a distal end 541 of the collar 540 may be slipped over a flange portion 537 of the connector 530, extending radially outward and axially rearward of the connector stem portion 535. As shown in FIG. 17B, a second end of the collar 540, extending distally from an intermediate portion of the collar surrounding the connector stem portion 535, is compressed or crimped radially inward (e.g., by crimping tool C) against the outer surface of the inner tube 510 to compress the distal end 511 of the inner tube 510 into secure gripping and sealing engagement with the barbed stem portion 535 and the internal surface of the collar 540. The length of the stem portion 535 may be selected to provide an elongated or extended sealing engagement with the inner tube 510, to further reduce gas permeation along the compressed portion of the inner tube. In an exemplary embodiment, a connector is utilized having a stem length to inner bore diameter ratio of at least about 5:1; for example, a connector having an inner bore diameter of about 0.14 inches and a stem length of about 0.7 inches.

In some embodiments, the distal end 541 of the collar 540 may be crimped against the connector flange portion 537, for example, to provide a limit to the degree of crimping, to provide a mechanical interlock, and/or to provide a second weld location. In the illustrated embodiment, the distal end 541 of the collar 540 includes an inner flange or dog lock 546 that aligns with and is crimped into a groove 538 in the connector 530 to provide a robust mechanical interlock between the connector and the collar.

As shown, the flange 537 may define a radial surface 537b positioned to align with at least a portion of the inner tube 510. In some embodiments, the inner tube 510 may be properly installed over the stem portion 535 of the connector 530 by advancing an end face 511a of the inner tube into abutment with the radial surface 537b of the flange portion 537. In other embodiments, a gauging tool (not shown) may be used (e.g., engaged with an exterior groove or step in the connector) to gauge proper installation of the inner tube over the connector stem portion.

While the collar may be provided in a variety of structures and geometries, in the illustrated embodiment, the collar 540 is provided as a substantially tubular section, at least prior to deformation, for example, for cost efficiency, ease of manufacture, and ease of installation over the inner tube 510 and stem flange 537. The collar 540 may be provided with a substantially smooth internal bore, or with a roughened, knurled, or discontinuous (e.g., ribbed, toothed) internal surface, for example, to enhance gripping of the collar against the inner tube or flange portion.

Where the outer tube is utilized to provide a leak-tight, gas-impermeable shell or sheath around a gas permeable inner tube, a gas impermeable connection between the outer tube and the collar may be provided. While many different types of attachments may be made between the outer tube 520 and the collar 540, in one embodiment, a weld connection is provided between the outer tube and the connector to provide a leak-tight, gas impermeable connection between the outer tube and the connector. To provide for a welded connection, the outer tube 520 and collar 540 may be provided in suitable materials, such as, for example, stainless steel, Hastelloy C-22, or Monel, which may be selected based on external corrosion resistance, or other factors. As used herein the term “welding” is to be accorded its broadest interpretation and encompasses various types of welding as well as the concepts of brazing and soldering.

Many different types of weld connections may be utilized. In the illustrated embodiments of FIGS. 17A and 17B, a distal endmost corrugation 523 of the outer tube 520 is truncated to define a counterbore portion 523a, and a proximal end 542 of the collar 540 is received in (e.g., in abutment with) and welded to the counterbore portion of the outer metal tube (e.g., using an orbital weld).

The welded metal arrangement of the outer tube 520 and collar 540 may provide a gas impermeable shell (e.g., having a gas permeability of less than about 1×10⁻⁵ see/sec or between about 1×10⁻⁹ scc/sec and about 1×10⁻⁷ scc/sec) around a gas permeable inner tube 510 (e.g., having a gas permeability of greater than about 1×10⁻⁴ scc/sec, or between about 1×10-3 scc/sec and about 1×10⁻² scc/sec). The crimped engagement of the inner tube distal end 511 with the barbed stem portion 535 may provide adequate gas impermeability (e.g., a gas permeability of less than about 1×10⁻⁵ scc/sec or between about 1×10⁻⁷ scc/sec and about 1×10⁻⁵ scc/sec), for example, in lower pressure applications (e.g., less than about 200 psi).

In an exemplary method of making a hose assembly, a corrugated outer metal tube 520 is provided, having a distal endmost corrugation 523 truncated to define a counterbore portion 523a. A proximal portion 542 of a collar 540 is received in the counterbore portion 523a of the outer metal tube 520, and the proximal portion of the collar is welded to the counterbore portion of the outer metal tube to form a weld zone W1. A distal end 511 of an inner tube 510 is inserted through the outer metal tube 520 and the collar 540, and a stem portion 535 of a connector 530 is inserted into the distal end of the inner tube. A distal portion 541 of the collar 540 is crimped into radial compression against the inner tube 510 for radial compression of the inner tube against the stem portion 535 of the connector 530.

According to another aspect of the present disclosure, a multi-layer or hybrid hose assembly having radially spaced inner and outer conduits (e.g., any of the hybrid hose arrangements described herein), may be provided with an additional external outer conduit surrounding and radially spaced from the first outer conduit, for example, to provide an additional gas impermeable barrier, a contained ported annular cavity for leakage testing, and/or an insulating space (e.g., vacuum insulation, insulating materials, heating/cooling fluids).

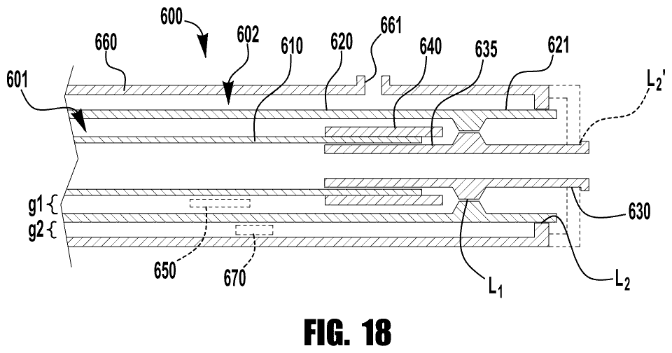

FIG. 18 schematically illustrates an exemplary hose 600 includes an inner tube 610 (which may, but need not, include a reinforcing sheath), a connector 630 secured to a distal end portion 611 of the inner tube, a first outer conduit 620 surrounding the inner tube 610 and secured (e.g. crimped, coupled, or welded) to the connector at a first location L1, and a second outer conduit 660 surrounding the first outer conduit and secured (e.g., crimped, coupled, or welded) to a distal end portion 621 of the first outer conduit at a second location L2. In other embodiments, the second outer conduit may be secured (e.g., crimped, coupled, or welded) to a distal end portion of the connector (as shown in phantom at L2′).

In some embodiments, an internal collar 640 may be included for radial compression of the inner tube distal end 611 against a stem portion 635 of the connector 630 (or against a separate anchor member, not shown), as described in other embodiments herein. The connector 630 may be provided with a variety of end connections for installation into a fluid system, including, for example, tube fittings, tube ends (e.g., for welding or installation in a tube fitting), quick disconnect couplings, or zero clearance face seal fittings.

The inner tube 610 and first and second outer conduits 620, 660 may be provided in any combination of suitable materials, as described with regard to the other embodiments disclosed herein, including, for example, a reinforcement material (e.g. braided metal sheath) provided on or in a plastic inner tube (not shown). The first outer conduit 620 may be sized to provide a first radial gap g1 defining a first annular cavity 601 between the inner tube 610 and the first outer conduit, and the second outer conduit 660 may be sized to provide a second radial gap g2 defining a second annular cavity 602 between the first outer conduit and the second outer conduit. While the radial gaps g1, g2 may be minimized to minimize the outer diameter of the hose assembly (e.g., for efficient storage and routing), in other embodiments, larger radial gaps may be provided to allow for the inclusion of radiant barrier material, insulation material, sensors (e.g., thermocouples, strain gauges), and/or other such materials or components (represented schematically at 650, 670). The second outer conduit 660 may include a port 661 intersecting the conduit wall, for example, to supply a conditioning fluid, to apply a vacuum, and/or to test for leakage in the second annular cavity 602.

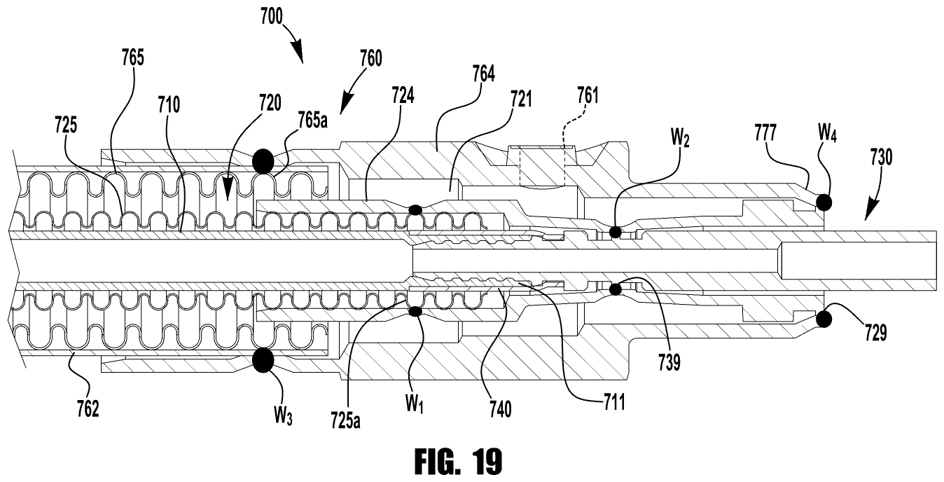

FIGS. 19-24 illustrate an exemplary hose 700 including an inner tube 710, a first outer conduit 720 formed from a first corrugated metal tube 725 and a first outer collar 724, a connector 730 secured to distal ends 711, 721 of the inner tube and first outer collar, and a second outer conduit 760 formed from a second corrugated metal tube 765 and a second outer collar 764 secured to the first outer collar. As shown, the inner tube 710, first outer conduit 720, and connector 730 may be similar to the corresponding components (having like reference numbers) of the hose assembly 300 of FIGS. 9-12, and may similarly be provided with an inner collar 740 surrounded by the first outer conduit 720 and in radial compression against the inner tube distal end 711 and the connector to secure the inner tube in sealing retention with the connector.

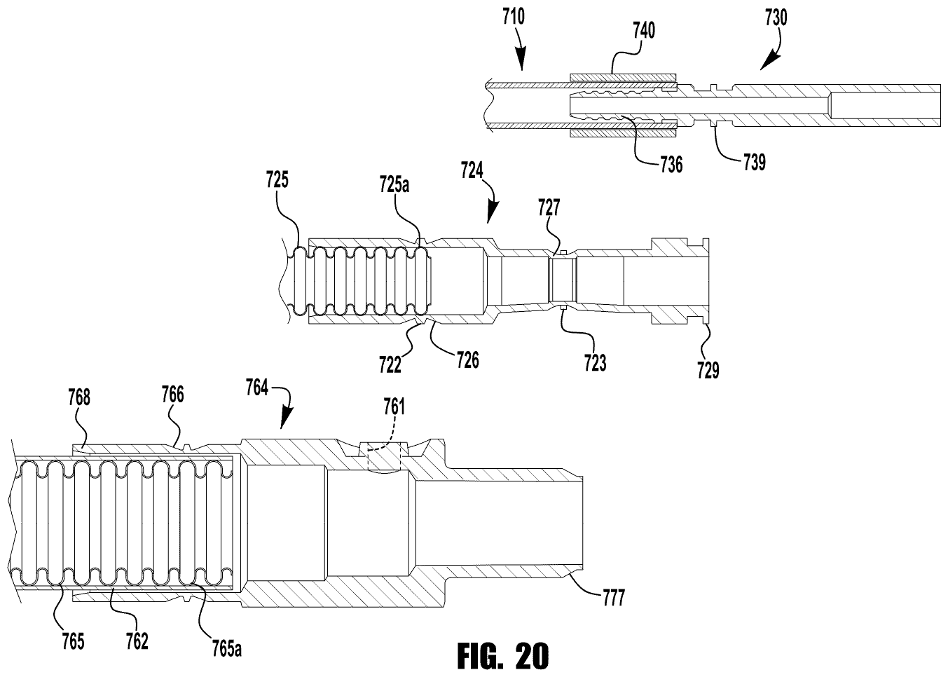

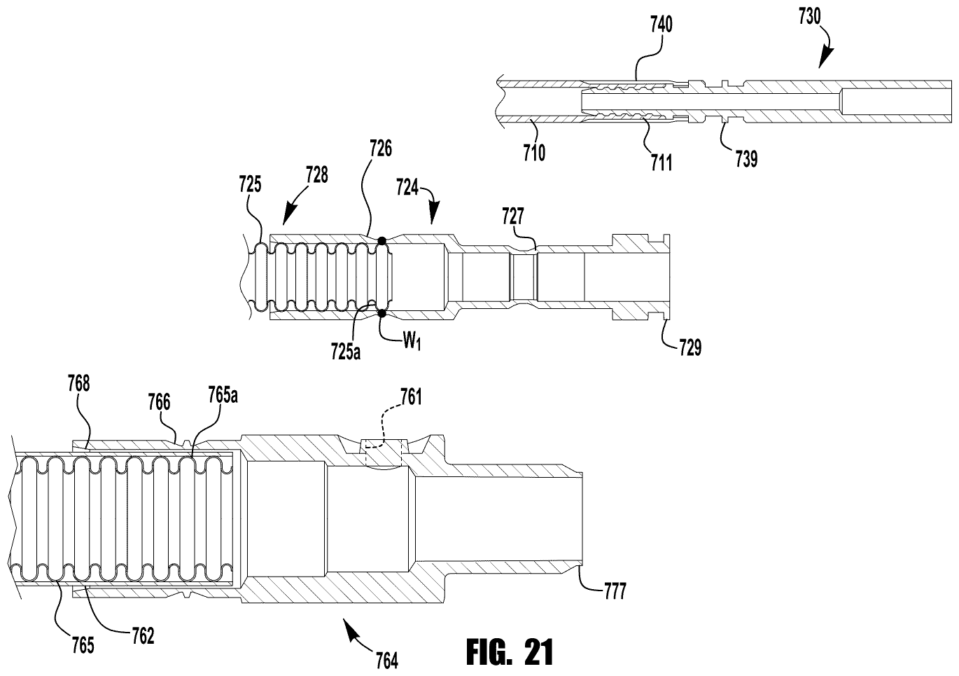

FIG. 20 illustrates the inner tube 710, first outer tube 725, first outer collar 724, connector 730, inner collar 740, second outer tube 765, and second outer collar 764 in a preassembled condition, with the inner collar in a pre-crimped condition and the first and second outer collars 724, 764 not yet welded to the first and second outer metal tube 725, 765. As shown, the inner collar 740 is slipped over the distal end portion 711 of the inner tube 710, and the barbed stem portion 735 of the connector 730 is inserted into the inner tube 710. As shown in FIG. 21, the inner collar 740 is compressed or crimped radially inward (e.g., by a crimping tool) against the outer surface of the inner tube 710 to compress the distal end 711 of the inner tube 710 into secure gripping engagement with the barbed stem portion 735, using, for example, any of the structure and arrangements described herein.

In some implementations, the first outer collar 724 may be welded to the first metal tube 725 before the inner tube 710 is installed within the outer tube, for example, to avoid exposure of the inner tube to heat from the welding operation. In an exemplary arrangement, the proximal end portion 728 of the first outer collar 724 is slipped over the first outer tube 725 such that a thinned down proximal weld region 726 of the first outer collar aligns with a portion (e.g., a corrugated crest portion 725a) of the first outer tube (FIG. 20). The proximate weld region 726 is then crimped radially inward against the outer tube portion 725a for welding at a proximal weld location W1 (FIG. 21). In some arrangements, the proximal weld region 726 of the first outer collar 724 may (but need not) include an enlarged rib 722 providing sacrificial weld material to facilitate formation of the autogenous weld. This enlarged rib 722 may further facilitate weld positioning or component alignment. In other embodiments, the welded assembly may use a filler material. Further, the welding operation may involve movement of the weld electrode around the weld collar (i.e., an orbital weld), or rotation of the workpiece components proximate a stationary electrode.

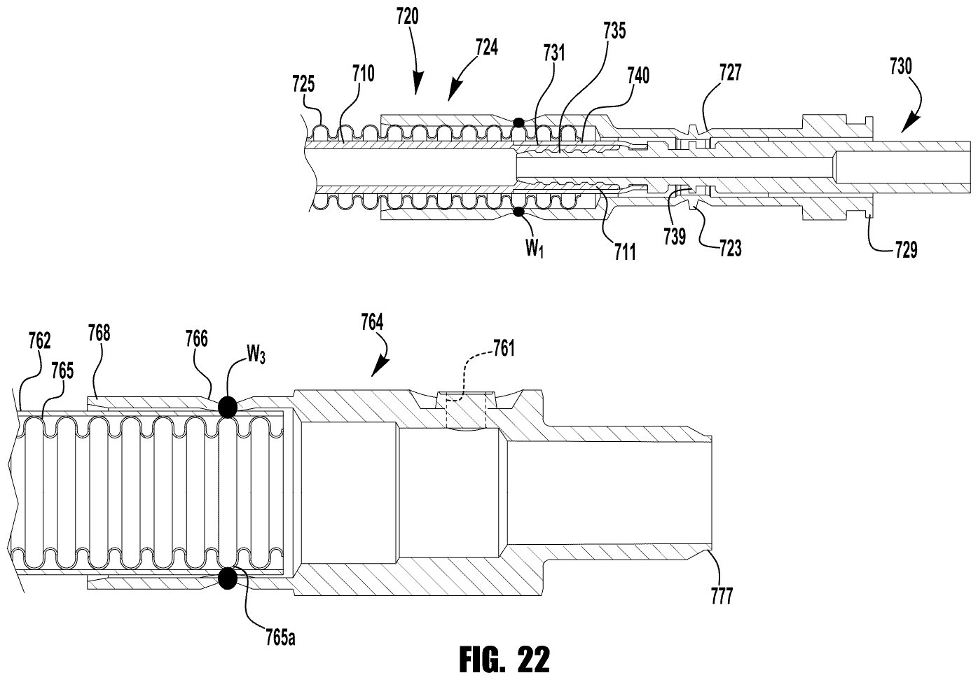

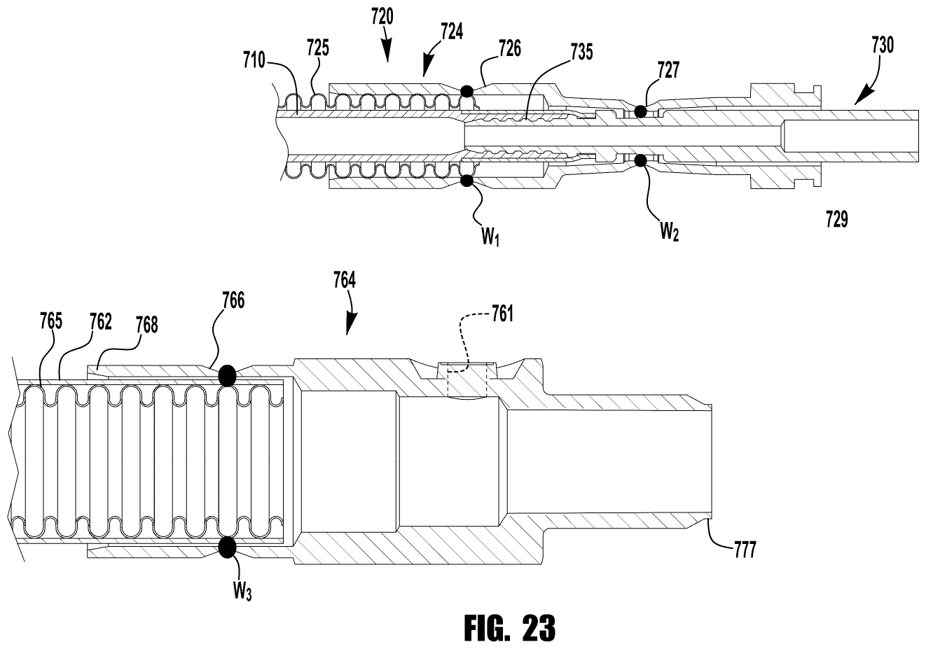

The inner tube 710, inner collar 740, and proximal end 731 of the connector 730 may then be inserted into the welded first outer conduit subassembly 720, such that a thinned down distal weld region 727 aligns with a distal flange 739 of the connector 730 (FIG. 22). The distal weld region 727 may then be crimped into radial engagement with the distal flange 739, for welding (e.g., orbital welding) at a distal weld location W2, as shown in FIG. 23. In some arrangements, the distal weld region 727 of the first outer collar 724 may (but need not) include an enlarged rib 723 providing sacrificial weld material to facilitate formation of the autogenous weld. This enlarged rib 723 may further facilitate weld positioning or component alignment. In other embodiments, the welded assembly may use a filler material. Further, the welding operation may involve movement of the weld electrode around the weld collar (i.e., an orbital weld), or rotation of the workpiece components proximate a stationary electrode.

The welded metal arrangement of the corrugated first outer tube 725, first outer collar 724, and connector 730 may provide a gas impermeable shell (e.g., having a gas permeability of less than about 1×10⁻⁵ scc/sec or between about 1×10⁻⁹ scc/sec and about 1×10⁻⁷ scc/sec) around a gas permeable inner tube 710 (e.g., having a gas permeability of greater than about 1×10⁻⁴ scc/sec, or between about 1×10⁻³ scc/sec and about 1×10⁻² scc/sec).

In some implementations, the second outer collar 764 may be welded to the second metal tube 765 before the inner tube 710 and first outer conduit 720 are installed within the second outer conduit 760, for example, to avoid exposure of the plastic inner tube to heat from the welding operation. In an exemplary arrangement, as shown in FIGS. 20 and 21, the proximal end portion 768 of the second outer collar 764 is slipped over the second outer tube 765 such that a thinned down proximal weld region 766 of the first outer collar aligns with a portion (e.g., a corrugated crest portion 765a) of the second outer tube. As shown in FIG. 22, the proximate weld region 766 is then crimped radially inward against the outer tube portion 765a for welding at a proximal weld location W3. As shown, a metal outer sheath 762 (e.g., braided metal sheath) may be provided over the corrugated second outer tube 765 and captured between the crimped proximal weld region 766 and the second outer tube, for weld penetration of the outer sheath 762 during the welding operation.

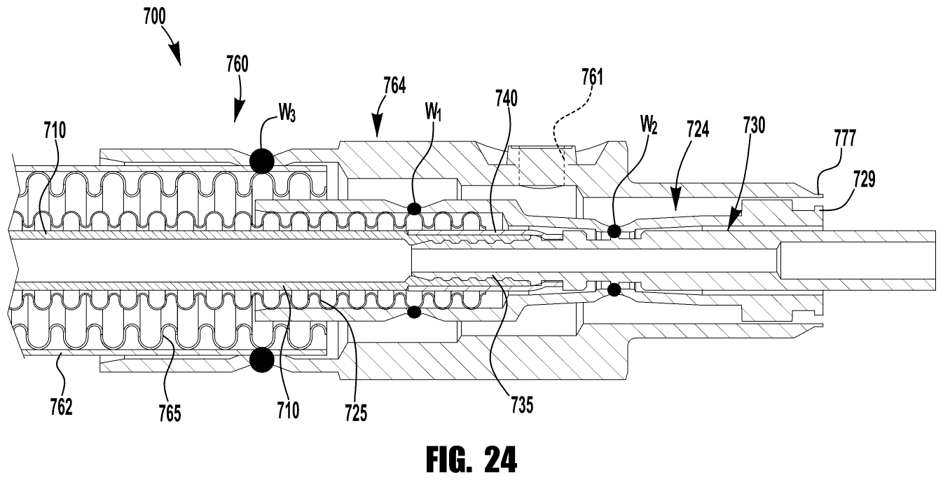

As shown in FIG. 24, the inner hose subassembly (i.e., inner tube 710, inner collar 740, first outer conduit 720, and connector 730) may then be inserted into the welded second outer conduit subassembly 760, such that a thinned down distal weld region 777 aligns with a distal flange 729 of the first outer collar 724. The distal weld region 777 may then be crimped into radial engagement with the distal flange 729, for welding (e.g., orbital welding) at a distal weld location W4, as shown in FIG. 19. The welding operation may involve movement of the weld electrode around the weld collar (i.e., an orbital weld), or rotation of the workpiece components proximate a stationary electrode.

The welded metal arrangement of the corrugated second outer tube 765, second outer collar 764, and first outer collar 724 may provide a gas impermeable shell (e.g., having a gas permeability of less than about 1×10⁻⁵ see/sec or between about 1×10⁻⁹ scc/sec and about 1×10⁻⁷ scc/sec). As shown, the second outer collar 764 may include a side port 761 intersecting the second outer collar wall, for example, to supply a conditioning fluid, to apply a vacuum, and/or to test for leakage in the second annular cavity 702.

The inventive aspects have been described with reference to the exemplary embodiments. Modification and alterations will occur to others upon a reading and understanding of this specification. It is intended to include all such modifications and alterations insofar as they come within the scope of the appended claims or the equivalents thereof.

1. A hose assembly comprising:
an inner tube;
a connector including a stem portion inserted into a distal end of the inner tube and a body portion extending radially outward and axially rearward of the stem portion;
a collar substantially coaxial with and surrounding the distal end of the inner tube, the collar being in radial compression against the inner tube; and
an outer metal conduit substantially coaxial with and surrounding the inner tube and the collar, the outer metal conduit terminating at a distal end attached to the body portion of the connector by a weld arrangement.

2. The hose assembly of claim 1, wherein the body portion of the connector comprises a body flange, the distal end of the outer metal conduit being welded to the body flange.

3.-5. (canceled)

6. The hose assembly of claim 1, wherein the stem portion of the connector comprises a stem flange, the collar being in radial compression against the stem flange.

7. The hose assembly of claim 6, wherein an end face of the inner tube abuts a radial surface of the stem flange.

8. The hose assembly of claim 6, wherein the inner tube comprises a reinforcement layer secured to a tubular core element, and wherein a distal end portion of the reinforcement layer is radially compressed between the collar and the stem flange.

9. (canceled)

10. The hose assembly of claim 6, wherein the connector includes an annular recess disposed between the stem flange and the body portion, wherein a distal end portion of the collar is staked into the annular recess.

11.-22. (canceled)

23. The hose assembly claim 1, wherein the outer metal conduit comprises an outer tube and an outer collar, with a distal end portion of the outer tube welded to a proximal end portion of the outer collar, and a distal end portion of the outer collar welded to the connector.

24. The hose assembly of claim 23, wherein the proximal end portion of the outer collar includes a hook portion shaped to engage an endmost corrugation of the outer tube.

25. The hose assembly of claim 23, wherein the proximal end portion of the outer collar includes a weld region welded to an axially aligned corrugation of the outer tube.

26. The hose assembly of claim 23, wherein the distal end portion of the outer collar includes a weld region welded to an axially aligned distal flange of the connector.

27. The hose assembly of claim 1, wherein the outer metal conduit comprises a first outer metal conduit, the hose assembly further comprising a second outer metal conduit substantially coaxial with and surrounding the first outer metal conduit, with the second outer metal conduit terminating at a distal end portion attached to one of the first outer metal conduit and the connector.

28.-36. (canceled)

37. A hose assembly comprising:
an inner tube;
a connector including a stem portion inserted into a distal end of the inner tube and a body portion extending radially outward and axially rearward of the stem portion;
a first outer metal conduit substantially coaxial with and surrounding the inner tube and the collar, the outer metal conduit terminating at a distal end attached to the body portion of the connector; and
a second outer metal conduit substantially coaxial with and surrounding the first outer metal conduit, with the second outer metal conduit terminating at a distal end portion attached to one of the first outer metal conduit and the connector.

38. The hose assembly of claim 37, wherein the distal end portion of the second outer metal conduit includes a weld region welded to an axially aligned flange portion of the distal end portion of the one of the first outer metal conduit and the connector.

39. The hose assembly of claim 37, wherein the distal end portion of the second outer metal conduit is welded to the distal end portion of the first outer metal conduit.

40. The hose assembly of claim 37, wherein the distal end portion of the second outer metal conduit is welded to the distal end portion of the connector.

41. The hose assembly of claim 37, wherein the second outer metal conduit comprises a second outer tube and a second outer collar, with a distal end portion of the second outer tube welded to a proximal end portion of the second outer collar, and a distal end portion of the second outer collar defining the distal end portion of the second outer metal conduit.

42. The hose assembly of claim 41, wherein the proximal end portion of the second outer collar includes a weld region welded to an axially aligned corrugation of the second outer tube.

43. The hose assembly of claim 41, wherein the distal end portion of the second outer collar includes a weld region welded to an axially aligned distal flange of the first outer conduit.

44. The hose assembly of claim 37, wherein the second outer metal conduit includes a port intersecting a wall portion of the second outer metal conduit.

45.-91. (canceled)

92. A hose assembly comprising:
an inner tube;
an outer metal conduit substantially coaxial with and surrounding the inner tube; and
a connector including a proximal end portion closely receiving a distal end portion of the outer metal conduit, an intermediate portion in radial compression against a distal end portion of the inner tube, and a distal end portion defining an end connection;
wherein the proximal end portion of the connector is welded to the distal end portion of the outer metal conduit.

93.-98. (canceled)
